(19) United States
(12) Patent Application Publication
(10) Pub. No.: US 2006/0072047 A1
(43) Pub. Date: Apr. 6, 2006

(54) Liquid crystal display

(76) Inventor: Kanetaka Sekiguchi, Sayama-shi (JP)

Correspondence Address: SUGHRUE MION, PLLC, 2100 PENNSYLVANIA AVENUE, N.W., SUITE 800, WASHINGTON, DC, 20037, US

(21) Appl. No.: 10/537,780

(22) PCT Filed: Sep. 23, 2003
(86) PCT No.: PCT/JP03/12281

§ 371 Date: Jun. 6, 2005

(30) Foreign Application Priority Data
Dec. 6, 2002 (JP) 2002-354634

(51) Int. Cl. G02F 1/135

(52) U.S. Cl. 349/25

(57) ABSTRACT

An EL element (33) is provided on a first substrate (1) to make it possible to perform both light emission display according to the EL element (33) and reflective display according to a liquid crystal display element. An EL control switching element (17) and a liquid crystal layer switching element (18) are provided on a face of the first substrate (1) positioned on the side of a liquid crystal layer (51). The EL control switching element (17) is connected to an anode electrode (21) or a cathode electrode (24) constituting the EL element (33). By connecting the liquid crystal layer switching element (18) to a display electrode (31) and a reflective electrode (28) constituting a liquid crystal display element, a liquid crystal display element and a light emitting element are integrated in a liquid crystal display device incorporated with the liquid crystal display element therein, so that thinning and weight reduction are achieved considering electrical connection therebetween and both reflective display and transmissive display are made possible.

### TECHNICAL FIELD

The present invention relates to a liquid crystal display device that incorporates an electroluminescent element (hereinafter, “EL element”) as a light source or a display element therein, and in particular to a liquid crystal display device usable as a reflective liquid crystal display device when the EL element is off.

### BACKGROUND ART

Transmissive-type liquid crystal display devices, in which the liquid crystals themselves do not emit light, performs displaying with transmitted light from a light source provided in the device are typically used in small-sized information apparatuses or the like. Apart form the transmissive-type liquid crystal display device, reflective liquid crystal display devices are known that utilizes reflected light of light entering in a liquid crystal display panel externally to perform displaying. Moreover, transflective-type liquid crystal display devices are known as having both functions of transmissive type and reflective type.

Liquid crystal display devices have been proposed in which material with light emitting property is used for a portion of a liquid crystal display panel and displaying is performed utilizing electro-optic change of liquid crystal (for example, Patent Literature 1 (Japanese Patent Application Laid-open No. H60-50578) and Patent Literature 2 (Japanese Patent Application Laid-open No. H60-129780)).

Liquid crystal display devices have been proposed in which a light source for emitting ultraviolet light is located on an opposite side (a back side of the liquid crystal display panel) of a liquid crystal display panel as viewed from a person (hereinafter, “a viewer”) who looks at the liquid crystal display panel and a polarizing separator having polarizing property to ultraviolet light is located between the light source and the liquid crystal display panel. In such liquid crystal display devices, a dichroic ratio of fluorescent dichroic dye, which is guest, is improved so that the visibility is also improved. However, in the liquid crystal display devices that use fluorescent dichroic dye, the fluorescent dichroic dye merely emits light secondarily owing to presence of an external light source (an auxiliary light source); in other words, an auxiliary light source is required in such devices.

On the other hand, research and development for an organic EL element are advancing rapidly, and the organic EL element has reached to a stage in which it is put into practical use in real product such as car audio sets or portable telephones. Furthermore, regarding the organic EL element, an example where a high performance is achieved using a semiconductor switching element, an example where high luminance is attained by using an EL element made from phosphor material, an example where reduction in weight and thickness is achieved by plastic board constitution, and the like have been reported.

FIG. 28 is an enlarged sectional view of principal portions of a display device that uses a conventional EL element. Referring to FIG. 28, a constitution of a conventional EL element is explained. In the explanation, the term “on” indicates “under” in FIG. 28. As shown in FIG. 28, an anode electrode 21 made from a transparent electric conductive film and a positioning insulating-film 20 are provided on a transparent first substrate 1. The positioning insulating-film 20 covers only the edges of the anode electrode 21; in other words, there is no positioning insulating-film 20 on the central portion of the anode electrode 21. Thus, the central portion of the anode electrode 21 becomes the light emitting region. A hole transporting layer 35, a light emitting layer 23, and an electron transporting layer 22 are stacked on the anode electrode 21 in this order. A cathode electrode 24 is stacked on the electron transporting layer 22. The positioning insulating-film 20 is sandwiched between the anode electrode 21 and the cathode electrode 24 and therefore prevents them from electrically short-circuiting.

The anode electrode 21, the hole transporting layer 35, the light emitting layer 23, the electron transporting layer 22, and the cathode electrode 24 make an EL element 33. It is know that the light emitting luminance of EL elements lower if there is moisture. To prevent lowering of the light emitting luminance, a metal case 30 is adhered to the first substrate 1 and an air layer 38, which does not content moisture, is filled in the space between the first substrate 1 and the metal case 30.

Transmissive emission light 61 output by the EL element 33 passes through the anode electrode 21 and the first substrate 1 and is seen by the viewer. The cathode electrode 24 is made from a metal film with a reflectance having a small work function, such as a lithium oxide-aluminum (Li₂O—Al) film, to allow effective emission of light emitted from the light emitting layer 23 toward the first substrate 1. The anode electrode 21 is made from, for example, indium tin oxide (ITO) film. The hole transporting layer 35 is made from, for example, a triphenylamine derivative. The light emitting layer 23 is made from, for example, iridium complex (Ir (ppy) 3). The electron transporting layer 22 is made from, for example, tris (8-quinolinolate) aluminum (3) complex.

The cathode electrode 24 is made from a reflective metal film and it reflects light from an external light source. As a result, if the external environment is bright and reflective light at the cathode electrode 24 is strong, a difference in the light intensities of the reflective light and transmissive emission light 61 from the EL element 33 is small. Therefore, an optical compensator 56 and a polarizing film 55 are stacked on the viewer's side of the first substrate 1 in this order, and they function as a 1/4 wavelength polarizing filter. Thereby, light from an external light source (not shown) is not emitted toward the viewer's side, even if it is reflected by the cathode electrode 24. Accordingly, a sufficiently large contrast ratio can be obtained between the transmissive emission light 61 and the reflective light.

Liquid crystal display devices that use EL elements as illuminating light sources of the back light for obtaining bright and sufficient contrast ratio have been known (for example, see Patent Literature 3 (JP-A-2000-267091), Patent Literature 4 (JP-A-58-221828), Patent Literature 5 (JU-A-59-53335), Patent Literature 6 (JP-A-2001-166300), and Patent Literature 7 (JP-A-11-249130)). In such liquid crystal display devices, when the external environment is dark, display is performed with transmissive light from the EL element obtained by lightening an EL element at a predetermined brightness and driving liquid crystal display elements in the lighted state.

However, in the display devices that use the conventional EL elements, when light intensity of an external light source is very strong, since intensity of transmissive emission light from the EL element is less than the intensity of reflective light at the cathode electrode, the transmissive emission light can be hardly recognized, and the contrast ratio is low. To avoid such an inconvenience, it is necessary to increase the intensity of the light emitted from the EL element; however, this results in increase in the power consumption of the EL element. If the power consumption increases, battery drain becomes sharp in the small-sized portable information devices, the portable telephones, the personal digital assistants (PDAs), the small-sized game machines, the watches, or the like, so that a sufficient use time can not be secured. Battery deterioration is also accelerated.

On the other hand, in the reflective liquid crystal display devices, even if the light intensity of the external light source is strong, such an inconvenience in the EL element described above does not occur. Instead, in an environment that light intensity of an external light source is weak or an environment that light from an external light source is not present, display becomes unrecognizable. In the transflective-type liquid crystal display devices or the reflective liquid crystal display devices having a front illumination constituted of a light guiding plate arranged on the viewer's side of a liquid crystal display panel, since it is necessary to provide light source outside the liquid crystal display panel, thinning or weight-reduction is limited. Connection of a light source or a constitution where the light source and the liquid crystal display element are formed in a module is complicated.

Further, in the liquid crystal display devices that incorporate the conventional EL elements therein, such a constitution is not employed that desired displaying is conducted by controlling light emitting intensity of the EL element, but the light emitting element is merely used as an illumination light source for the liquid crystal display element. Therefore, even during lightening of the EL element, it is necessary to drive the liquid crystal display element, which results in increase in power consumption.

For solving the problems in the conventional art, an object of the invention is to unitize a liquid crystal display element and a light emitting element serving as a display element and perform thinning and reduction in weight considering electrical connection therebetween. That is, an object of the present invention is to provide a liquid crystal display device incorporating a light emitting element serving as a display device therein.

Further, a switching element is provided in the liquid crystal display device and a liquid crystal display pixel electrode and the light emitting element are controlled by the switching element, so that it is made possible to improve display quality on a liquid crystal display panel, achieve low power consumption and improve visibility.

### DISCLOSURE OF THE INVENTION

To solve the above problems and to achieve the above objects, according to an aspect of the present invention, a liquid crystal display device where a first substrate having a display electrode and a second substrate having an opposite electrode are disposed so as to be opposed to each other via a predetermined clearance, and a liquid crystal display element having a liquid crystal layer is provided in the clearance, wherein an EL element and an EL control switching element for controlling the EL element are provided between the first substrate and the second substrate; and a liquid crystal layer switching element for supplying a signal for display to the liquid crystal layer is further provided between the first substrate and the second substrate to be connected to the display electrode.

Moreover, in the liquid crystal display, the EL control switching element is formed on a liquid crystal layer side of the first substrate, and the EL element is formed on a liquid crystal side of the EL control switching element via an insulating film.

Moreover, in the liquid crystal display, the EL element is formed on a liquid crystal layer side of the first substrate, and an EL control switching element is formed on a liquid crystal layer side of the EL element via an insulating film.

Moreover, in the liquid crystal display, the EL element allows light to transmit the first substrate to go out to a side of the first substrate.

Moreover, in the liquid crystal display, an EL connecting opening is formed in the insulating film, and the EL element and the EL control switching element are electrically connected to each other via the EL connecting opening.

Moreover, in the liquid crystal display, the EL element comprises plural kinds of EL elements that emit different color lights, respectively.

Moreover, in the liquid crystal display, a protective film that prevents moisture from permeating the EL element is provided on the EL element.

Moreover, in the liquid crystal display, an insulating planarizing film for planarizing a step is formed on the EL element or the EL control switching element, and a display electrode for the liquid crystal display element is formed on the planarizing film.

Moreover, in the liquid crystal display, the planarizing film is provided with a diffusing member that diffuses light.

Moreover, in the liquid crystal display, the display electrode is a reflective electrode and has an opening in its region overlapping with the EL element.

Moreover, in the liquid crystal display, a surface of the reflective electrode is formed in an undulated shape.

Moreover, in the liquid crystal display, a surface of the planarizing film is formed in an undulated shape.

Moreover, the liquid crystal display further comprises a liquid crystal layer switching element for supplying a signal for display to the liquid crystal layer between the first substrate and the second substrate to be connected to the display electrode.

Moreover, in the liquid crystal display, a display electrode is formed on a liquid crystal layer side of the liquid crystal layer switching element, and the display electrode and the switching element for liquid crystal display layer control are electrically connected to each other via an LC connecting opening formed in the insulating film.

Moreover, in the liquid crystal display, the display electrode is formed on a region that approximately covers a set of two switching elements comprising the liquid crystal layer switching element and the EL control switching element.

Moreover, in the liquid crystal display, the switching element comprises a thin film transistor having a source electrode, a drain electrode, and a gate electrode.

Moreover, in the liquid crystal display, the gate electrodes of the EL control switching element and the switching element for liquid crystal display element included in the same display pixel region are connected to each other and the source electrodes thereof are independent from each other.

Moreover, in the liquid crystal display, gate electrodes of the EL control switching elements included in two display pixel regions adjacent to each other, respectively, are connected to each other, gate electrodes of the liquid crystal layer switching elements included in two display pixel regions adjacent to each other, respectively, are connected to each other, and a source electrode of the EL control switching element is connected to a source electrode of the liquid crystal layer switching element included in an adjacent display pixel region.

Moreover, in the liquid crystal display, gate electrodes of the EL control switching elements included in two display pixel regions adjacent to each other, respectively, are connected to each other, gate electrodes of the liquid crystal layer switching elements included in two display pixel regions adjacent to each other, respectively, are independent from the gate electrodes of the EL control switching elements and are connected to each other, and source electrodes of the EL control switching element and the liquid crystal layer switching element are independent from each other.

Moreover, in the liquid crystal display, the switching element is a thin film transistor having a semiconductor layer made of a poly-silicon thin film.

Moreover, in the liquid crystal display, the EL control switching element is a thin film transistor having a semiconductor layer made of a poly-silicon thin film, and the liquid crystal layer switching element is a thin film transistor having a semiconductor layer made of an amorphous silicon film.

Moreover, the liquid crystal display further comprises a color filter disposed between the first substrate and the second substrate.

Moreover, in the liquid crystal display, the liquid crystal layer is a mixture of liquid crystal and transparent solid material, and is a scattering type liquid crystal layer that controls scattering and transmission according to magnitude of a voltage applied to the liquid crystal layer.

Moreover, the liquid crystal display further comprises an organic insulating film mixed with a member that absorbs moisture and disposed between the first substrate and the display electrode.

Moreover, the liquid crystal display further comprises at least a polarizing film on a side of the second substrate side opposite to the side on which the liquid crystal layer is provided.

Moreover, the liquid crystal display further comprises at least one optical compensator and a polarizing film disposed on a side of the second substrate opposed from the liquid crystal layer in this order from the second substrate side.

Moreover, the liquid crystal display further comprises a light diffusing layer positioned between the EL element and the polarizing film.

Moreover, the liquid crystal display further comprises a light diffusing layer positioned between the EL element and the second substrate.

Moreover, in the liquid crystal display, arrangement of an orientation direction of the liquid crystal layer, and the polarizing film and the optical compensator provided on a side of the second substrate opposed from the liquid crystal layer meets arrangement where a transmissivity of the liquid crystal layer becomes approximately maximum during non-application of a voltage to the liquid crystal layer.

Moreover, in the liquid crystal display, a voltage where the transmissivity of the liquid crystal layer becomes approximately maximum is applied to the liquid crystal layer via the liquid crystal layer switching element during light emission from the EL element.

Moreover, in the liquid crystal display, a display face of the liquid crystal display element is positioned on the side of the second substrate, and a light emitting face of the EL element is positioned on the side of the first substrate.

### BRIEF DESCRIPTION OF THE DRAWINGS

FIG. 1 is a partial enlarged sectional view of principal portions of a liquid crystal display device according to a first embodiment of the present invention;

FIG. 2 is a perspective of a portable information apparatus that incorporates the liquid crystal display device according to the present invention;

FIG. 3 is a sectional view of the portable information apparatus taken along line A-A in FIG. 2;

FIG. 4 is a partial enlarged sectional view of principal portions of a liquid crystal display device according to a second embodiment of the present invention;

FIG. 5 is a partial enlarged sectional view of principal portions of a liquid crystal display device according to a third embodiment of the present invention;

FIG. 6 is a partial enlarged sectional view of principal portions of a liquid crystal display device according to a fourth embodiment of the present invention;

FIG. 7 is a partial enlarged sectional view of principal portions of a liquid crystal display device according to a fifth embodiment of the present invention;

FIG. 8 is a partial enlarged sectional view of principal portions of a liquid crystal display device according to a sixth embodiment of the present invention;

FIG. 9 is a partial enlarged sectional view of principal portions of a liquid crystal display device according to a seventh embodiment of the present invention;

FIG. 10 is a partial enlarged sectional view of principal portions of a liquid crystal display device according to an eighth embodiment of the present invention;

FIG. 11 is a partial enlarged sectional view of principal portions of a liquid crystal display device according to a ninth embodiment of the present invention;

FIG. 12 is a plan view of principal portions of a display pixel region in a liquid crystal display device according to a tenth embodiment of the present invention;

FIG. 13 is a plan view of principal portions of a display pixel region in the liquid crystal display device according to the tenth embodiment of the present invention;

FIG. 14 is a plan view of principal portions of a display pixel region in the liquid crystal display device according to the tenth embodiment of the present invention;

FIG. 15 is a partial enlarged sectional view of principal portions of a liquid crystal display device according to an eleventh embodiment of the present invention;

FIG. 16 is a partial enlarged sectional view of principal portions of a liquid crystal display device according to a twelfth embodiment of the present invention;

FIG. 17 is a circuit diagram of an equivalent circuit of an EL element in the liquid crystal display device according to the present invention;

FIGS. 18A to 18D are waveforms of voltages applied to a gate electrode and light emitting intensities when an EL element in the liquid crystal display device according to the present invention is driven in a time-divisional manner;

FIG. 19 is a partial enlarged diagram showing one portion of a display section in a liquid crystal display device for explaining a driving pattern in the liquid crystal display device according to the present invention;

FIG. 20 is a driving waveform diagram obtained when only a liquid crystal display element in the liquid crystal display device according to the present invention is driven;

FIG. 21 depicts driving waveforms obtained when only the EL element in the liquid crystal display device according to the present invention is driven;

FIG. 22 depicts driving waveforms obtained when both a liquid crystal display element and an EL element in the liquid crystal display device according to the present invention are driven;

FIG. 23 is a perspective view of the portable telephone, with its lid open, to which the liquid crystal display device according to the present invention has been applied;

FIG. 24 is a perspective view of the portable telephone, with its lid close, to which the liquid crystal display device according to the present invention has been applied;

FIG. 25 is a circuit diagram of an equivalent circuit of a passive matrix type EL element;

FIGS. 26A to 26D are waveforms of voltages applied to a scanning electrode and light emitting intensities when the passive matrix type EL element is driven in a time-divisional manner;

FIG. 27 is a characteristic graph of a relationship between luminance of an organic EL element and applied voltage; and

FIG. 28 is a partial enlarged sectional view of principal portions of a display device that uses a conventional EL element.

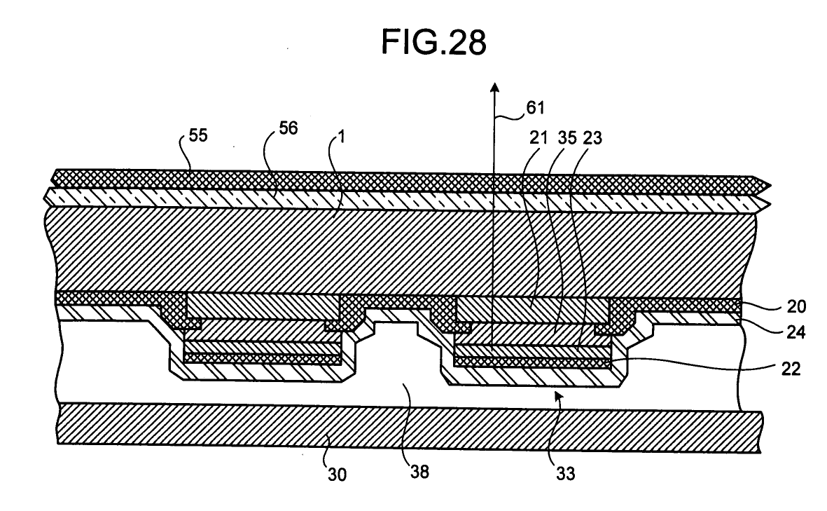

### BEST MODE FOR CARRYING OUT THE INVENTION

Exemplary embodiments of a liquid crystal display device of a light emitting element incorporated type that is a best mode for implementing the present invention will be explained below with reference to the drawings. Incidentally, in explanation about each embodiment described below, constitutions therein similar to those in the other embodiments will be attached same reference numerals and further explanation thereof is omitted.

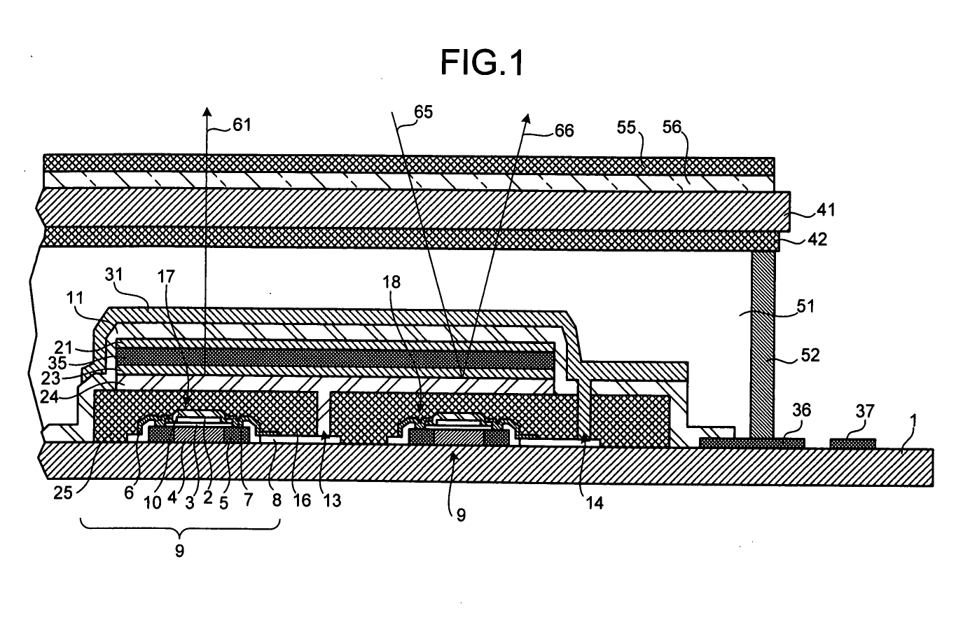

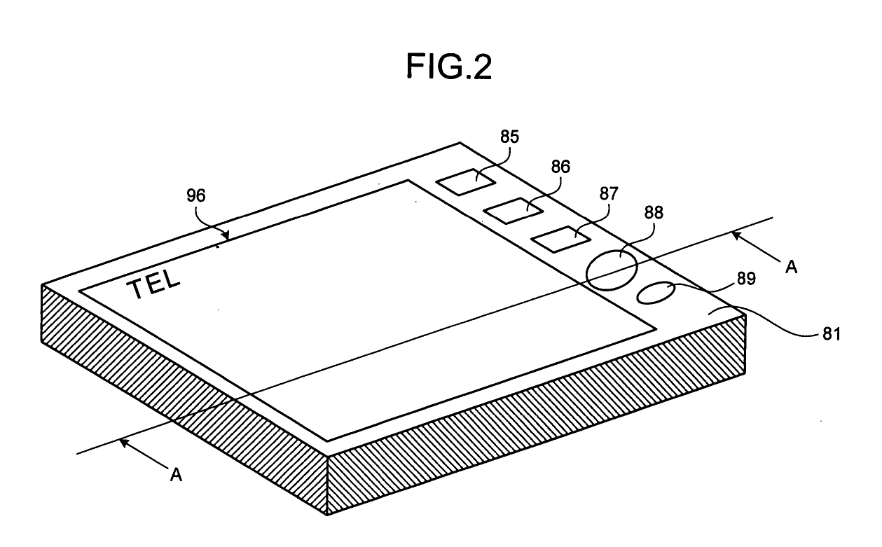

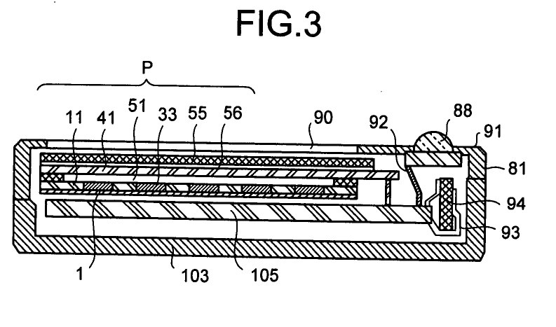

A liquid crystal display device according to a first embodiment is explained below with reference to FIGS. 1, 2, and 3. A feature of the first embodiment lies in that a switching element for controlling an EL element and a switching element for controlling a liquid crystal layer are formed on a first substrate. Another feature lies in that the switching element for controlling an EL element and the switching element for controlling a liquid crystal layer are formed on the same face. Still another feature lies in that a reflective electrode constituting an EL element is utilized as a reflection film for the liquid crystal layer. FIG. 1 is a partial enlarged sectional view of a liquid crystal display device of a light emitting element incorporated type according to the first embodiment of the present invention. FIG. 2 is a perspective view of a portable information apparatus that incorporates the liquid crystal display device according to the present invention. FIG. 3 is a sectional view of the portable information apparatus taken along line A-A shown in FIG. 2.

As shown in FIG. 2, a display unit 96 for displaying an image is provided on a case of a portable information apparatus 81. A mode switching button 85 for changing display contents, a scroll-up (+) button 86, a scroll-down (−) button 87, a communication unit 88, and a switch button 89 that performs turning-on and turning-off of the portable information apparatus 81 are provided on the side of the display unit 96.

Next, as shown in FIG. 3, the portable information apparatus 81 is provided with a liquid crystal display device P and a windshield glass 90 through which a display unit of the liquid crystal display device P can be seen. A circuit board 105 is provided on the side of a back lid 103 of the case, and the liquid crystal display device P is mounted on the circuit board 105. The liquid crystal display device P has a basic constitution including a second substrate 41 provided with a second electrode (not shown in FIG. 3), a liquid crystal layer 51, and a first substrate 1 provided with a first electrode (not shown in FIG. 3) and an EL element 33 from the side of the windshield glass 90 (on the viewer's side). An organic EL element can be used as the EL element 33. The first substrate 1 and the second substrate 41 are parallel to each other with a predetermined gap therebetween and a liquid crystal layer 51 is sealed in a space defined by the first substrate 1 and the second substrate 41. The liquid crystal layer 51 is sealed by a sealing material and a hole sealing portion (not shown).

Further, an electrode (not shown) on the second substrate 41 is connected to a signal terminal on the circuit board 105 by an electrically conductive member (not shown). A communication unit 88 disposed on the case is mounted on a circuit board for communication 91. The circuit board for communication 91 is connected to the circuit board 105 via an FPC 92 constituted of a flexible printed circuit board (FPC). The communication unit 88 is for signal transmission and reception or for signal reception, and it is a GPS (global positioning system) sensor for position information, a Bluetooth and reception sensor, or an infrared transmission and reception sensor. A battery 94 serving as an energy source is mounted on the circuit board 105 by a battery retaining spring 93. In FIG. 3, a member denoted by reference numeral 11 is an insulating film for protection, a member denoted by reference numeral 55 is a polarizing film, and a member denoted by reference numeral 56 is an optical compensator.

As shown in FIG. 1, two kinds of thin film transistors (TFT) 9 formed from a poly-silicon film are provided on the first substrate 1. One thin film transistor 9 is an EL control switching element 17 that controls the EL element 33. The other thin film transistor 9 is a liquid crystal layer switching element 18 that controls the liquid crystal display element that is a low power consumption display element. The EL control switching element 17 and the liquid crystal layer switching element 18 together are formed on the same layer on the first substrate 1.

The thin film transistor 9 made from a poly-silicon semiconductor layer is produced in the following manner. First of all, a semiconductor layer 4 made from the poly-silicon film is formed on the first substrate 1. A gate insulating film 3 made of a silicon oxide film is formed on the semiconductor layer 4. A source contact hole and a drain contact hole are formed on a portion of the gate insulating film 3. Then, a source electrode 6 and a drain electrode 7 are electrically connected to an impurity-doped semiconductor region 5 made by doping impurities into the semiconductor layer 4 via the source contact hole and the drain contact hole, respectively. A gate electrode 2 made from tungsten (W) that is high melting point metal is formed on the gate insulating film 3.

A passivation film 10 is formed on the thin film transistor 9 thus formed. This is for preventing characteristics of the thin film transistor 9 from changing in a light emitting element forming step or in a liquid crystal display panel manufacturing step performed later. The drain electrode 7 is electrically connected to a drain connecting electrode 8.

A planarizing protective film 16 obtained by mixing material absorbing moisture into an organic insulating film made from acrylic resin or the like is formed on the thin film transistor 9 and the passivation film 10 as an interlayer insulating film 25. This is for stabilizing characteristics of the light emitting element and simultaneously preventing characteristic degradation of the thin film transistor 9. For example, fine particles of barium oxide are used as the moisture absorbing material. By dispersing fine particles of barium oxide into acrylic resin, a moisture getter function is given to the planarizing protective film 16. Incidentally, in FIG. 1, the planarizing protective film 16 is shown as a single layer, but it may be constituted in a multi-layer structure obtained by stacking an acrylic resin layer with moisture getter priority including much barium oxide and an acrylic resin layer for improving an insulating property and a planarizing property. When such a structure is employed, higher degradation preventing effect in the EL element 33 is obtained as compared with a case that the planarizing protective film 16 is constituted of a single layer.

An EL connecting opening 13 for electrically connecting the drain electrode 7 of the EL control switching element 17 and a cathode electrode 24 of the EL element 33 to each other via the drain connecting electrode 8 and an LC connecting opening 14 for electrically connecting the drain electrode 7 of the liquid crystal layer switching element 18 and the display electrode 31 constituting a liquid crystal display pixel to each other via the drain connecting electrode 8.

The cathode electrode 24 that is a reflective metal electrode of a third electrode is made from alloy of aluminum and magnesium on the planarizing protective film 16. An electron transporting layer (not shown) made from quinolinolenic aluminum complex (Alq), a light emitting layer 23 made of quinolinolenic aluminum complex doped with quinacridone, a hole transporting layer 35 made from triphenylamine derivative, and an anode electrode 21 of a fourth electrode made from indium tin oxide (ITO) film as a transparent electric conductive film are stacked on the cathode electrode 24 in this order. The EL element 33 is constituted of constitutions from the cathode electrode 24 to the anode electrode 21.

An insulating film for protection 11 made of an insulating film such as a silicon film oxide is provided on the EL element 33. This is for preventing moisture penetration into the EL element 33. A display electrode 31 made from indium tin oxide (ITO) film is provided on the insulating film for protection 11 as a transparent electric conductive film for driving a liquid crystal. As described above, the display electrode 31 is electrically connected to the drain connecting electrode 8 of the thin film transistor 9 constituting the liquid crystal layer switching element 18 via the LC connecting opening 14.

As explained above, the thin film transistors 9 provided on the first substrate 1 function as two kinds of elements for controlling two kinds of displaying elements, namely, the device for light emitting control to the EL element 33 and the device for voltage control to the liquid crystal layer 51 of the liquid crystal display element.

The second substrate 41 is opposed to the first substrate 1 with a predetermined clearance. An opposite electrode 42 covering a plurality of display electrodes 31 arranged in a matrix manner is provided on a face of the second substrate 41 positioned on the side of the liquid crystal layer 51. A crossing portion of the display electrode 31 and the opposite electrode 42 constitutes a liquid crystal display pixel. An orienting film (not shown) that arranges liquid crystal molecules in a predetermined direction is provided on a face of the first substrate 1 or the second substrate 41 facing the liquid crystal layer 51.

The first substrate 1 and the second substrate 41 are joined with a predetermined clearance therebetween by a sealing member 52. An input electrode 37 that connects the connecting electrode 36 mounted with a driving circuit unit (not shown) and an external circuit applying a predetermined signal to the driving circuit unit is provided on the first substrate 1 to apply a predetermined signal to the gate electrode or the source electrode.

A twist nematic (TN) liquid crystal layer 51 having a twist angle in a range of 60 degree to 70 degree is sealed in the clearance between the opposite electrode 42 and the display electrode 31. Under a bright external environment, reflection incoming light 65 from external light is elliptically polarized by the polarizing film 55 and the optical compensator 56 and modulated depending on a voltage applied to the liquid crystal layer 51 to reach the cathode electrode 24 that is the reflective electrode. Then, the light is polarized in a reversely twisted manner by the reflective electrode to pass through the liquid crystal layer 51 again and pass through the optical compensator 56 and the polarizing film 55 and is emitted to the viewer's side as reflection outgoing light 66. Display is performed by controlling strong reflective light and very weak reflective light according to electro-optic change of the liquid crystal layer 51.

The optical compensator 56 is constituted of a 1/4 wavelength film and a 1/2 wavelength film combined and it is set such that reflective light from the reflective electrode is made minimum averagely by the polarizing film 55 in the whole wavelength region of a visible light region when a retardation in the liquid crystal layer 51 is approximately 0.

On the other hand, under a dark external environment, since the liquid crystal layer 51 serving as a light receiving element is dark even in bright display, it becomes difficult to recognize lights and darks, so that the EL element 33 is lighted. At that time, a voltage for reducing retardation, namely, a large voltage is applied to the liquid crystal layer 51. This is for employing such a constitution that light emitted from the EL element 33 is hardly absorbed in the liquid crystal layer 51 and retardation hardly occurs in the liquid crystal layer 51. Further, under a dark external environment, such a constitution can be employed to achieve low power consumption as much as possible that the liquid crystal display element is of normally white type where it becomes transparent during non-application of voltage and a signal is not applied to the switching element 18 for liquid crystal layer control that drives the liquid crystal layer 51.

It is desirable for preventing reflection from the cathode electrode 24 efficiently under a bright external environment to provide the polarizing film 55 and the optical compensator 56.

Thus, in the first embodiment, such a constitution is employed that the EL control switching element 17 and the liquid crystal layer switching element 18 are provided on the first substrate 1 and both the switching elements 17 and 18 are covered with the cathode electrode 24 of the EL element 33. Therefore, these switching elements 17 and 18 do not block the EL element 33. Accordingly, a bright EL element 33 can be obtained.

Further, because the reflectivity of the cathode electrode 24 is utilized as the reflective electrode, the reflective electrode of the liquid crystal display element is not blocked by the EL control switching element 17 and the liquid crystal layer switching element 18. Accordingly, bright reflective display from the liquid crystal display element can be made possible.

When displaying is performed by light emission of the EL element 33, the polarizing film 55 and the retardation film 56 prevent reflective light at the cathode electrode 24 serving as the reflective electrode from emerging to contribute to increase in contrast between the reflective light and the transmissive incoming light 61 from the EL element 33. When displaying is performed by light emission of the EL element 33, a voltage for reducing retardation in the liquid crystal layer 51 is applied to the liquid crystal layer 51 to prevent light emitted from the EL element 33 from causing modulation of the liquid crystal layer 51 and optical change due to the retardation film 56 and the polarizing film 55 and prevent reflection from the cathode electrode 24.

In the first embodiment, silicon oxide film is used as the insulating film for protection 11, but such a constitution may be employed that another protective film made from acrylic resin with diffusing property is provided on the silicon oxide film as a light diffusing layer. In that case, when a viewer observes reflective display on the liquid crystal display element, it is made possible to expand a direction of a viewer who can recognize bright display. That is, since reflective light is diffused by the insulating film for protection 11, light is diffused in various directions so that a viewing angle is expanded.

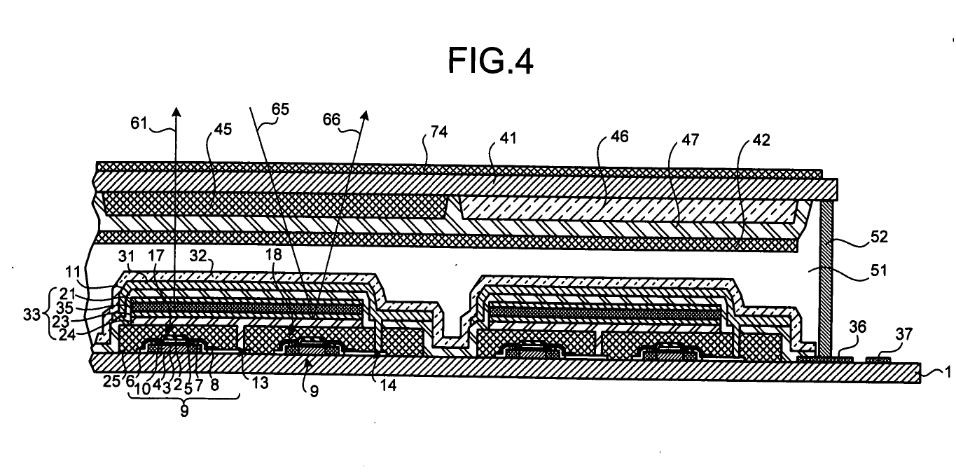

A liquid crystal display device according to a second embodiment is described below with reference to FIG. 4. A feature of the second embodiment lies in a point that a color filter is provided between the light emitting element and the second substrate. Further, it is also one of features that the light that is emitted from the light emitting element is white. FIG. 4 is a partial enlarged sectional view of principal portions of a liquid crystal display device according to the second embodiment of the present invention.

The EL control switching element 17 and the liquid crystal layer switching element 18 are provided at each pixel. The passivation film 10 and the interlayer insulating film 25 serving as an insulating film are provided on the switching elements 17, 18 like in the first embodiment, and the interlayer insulating film 25 is planarized.

The cathode electrode 24 constituting a reflective metal electrode serving as a third electrode is formed from alloy of aluminum and magnesium on the interlayer insulating film 25. An electron transporting layer (not shown) made from quinolinolenic aluminum complex (Alq), a light emitting layer 23 made of quinolinolenic aluminum complex doped with quinacridone, a hole transporting layer 35 made from triphenylamine derivative, and an anode electrode 21 of a fourth electrode made from indium tin oxide (ITO) film as a transparent electric conductive film are stacked on the cathode electrode 24 in this order. The EL element 33 is constituted of constitutions from the cathode electrode 24 to the anode electrode 21.

An insulating film for protection 11 is provided on the EL element 33 to prevent moisture from penetrating the EL element 33 and prevent the EL element 33 from degrading at subsequent steps. A display electrode 31 made from a transparent electric conductive film is provided on the insulating film for protection 11. A final protective film 32 is provided on the display electrode 31 to prevent moisture or impurities from entering.

The second substrate 41 is provided so as to be opposed to the first substrate 1 with a predetermined clearance. Color filters that allow lights of red, blue, and green in a visible light wavelength region to pass through are provided on a face of the second substrate 41 on the side of the liquid crystal layer 51. In FIG. 4, a red color filter 45 and a green color filter 46 have been shown and a blue color filter has been omitted. A CF overcoat layer 47 made from acrylic resin is provided on the color filters 45, 46 for red, blue, and green. An opposite electrode 42 made from a transparent electric conductive film is provided on a face of the CF overcoat layer 47 on the side of the liquid crystal layer 51 so as to cover the display electrodes 31 arranged in a matrix manner. An orienting film (not shown) that arranges liquid crystal molecules in a predetermined direction is provided on a face of the first substrate 1 or the second substrate 41 facing the liquid crystal layer 51.

The first substrate 1 and the second substrate 41 are joined with a predetermined clearance therebetween by a sealing member 52. An ultraviolet cutting film 74 is adhered on a face of the second substrate 41 opposed from the liquid crystal layer 51. The ultraviolet cutting film 74 prevents ultraviolet rays from advancing into the liquid crystal layer 51. An input electrode 37 that connects the connecting electrode 36 mounted with a driving circuit unit (not shown) and an external circuit applying a predetermined signal to the driving circuit unit is provided on the first substrate 1 to apply a predetermined signal to the gate electrode or the source electrode.

The liquid crystal layer 51 sealed between the first substrate 1 and the second substrate 41 is diffusing type liquid crystal obtained by mixing liquid crystal molecules and transparent solid material made from acrylic resin of organic polymer material. The acrylic resin is illustratively made from transparent solid material of a porous body, and modules diffuse and penetration by applying a voltage to the liquid crystal layer 51. The liquid crystal molecule has a refractive index (no) corresponding to normal light and a refractive index (ne) corresponding to abnormal light. A transparent state and a diffused state of liquid crystal occur depending on a differentiation between the refractive index (np) of the transparent solid material and the refractive indexes (no and ne) of liquid crystal molecule and orientation of the liquid crystal molecule. In the second embodiment, PNM-157 manufactured by Dainippon Ink And Chemicals, Incorporated is uses as material for the liquid crystal layer 51, and the liquid crystal layer is prepared by irradiating liquid crystal sealed with ultraviolet light with a wavelength of equal to or more than 360 nanometers (nm) at an intensity of 30 mW/cm² for 60 seconds. Regarding the refractive index of the liquid crystal and no is 1.5, ne is 1.7, and the refractive index of the transparent solid material is about 1.5.

Under a bright external environment, in the so-called liquid crystal display pixel with a large transmissivity where scattering of scattering type liquid crystal does not occur, reflection incoming light 65 from external light source light is regularly reflected by the cathode electrode 24 of the reflective electrode constituting the EL element 33 and the reflection outgoing light 66 is observed on the viewer's side. Further, in the liquid crystal display pixel with large diffusing, almost all of reflection incoming light 65 repeats fine diffusing reflection and penetrates the color filters 45, 46 as diffusing light, so that a viewer can recognize colors, and lights and darks. Since regularly reflective light does not go out except for a predetermined angle, it is recognized as dark display. Display for lights and darks is performed according to a difference between light intensities of the regular reflective light and the diffusing reflective light.

When the reflective display is performed, fine diffusing reflection within the liquid crystal layer 51 not only occurs but also reflective light from the reflective electrode provided on the side of the first substrate 1 repeats fine diffusing reflection within the liquid crystal layer 51 in the liquid crystal display pixel with large scattering. Therefore, outgoing intensity of the diffusing reflective light toward a viewer is made stronger than that from liquid crystal alone by the reflective electrode constituting the EL element 33. When transmissive display where the EL element 33 is lighted is performed, since the transmissive outgoing light 61 passes through the liquid crystal layer 51 only one time, the degree of diffusing lowers apparently, so that sufficient contrast can not be achieved.

In view of the above, it is effective to provide the EL element 33 corresponding to each liquid crystal display pixel. At a lighted pixel in the EL element 33, the liquid crystal layer 51 is transferred to a transmissive state. At a non-lighted pixel in the EL element 33, the liquid crystal layer 51 is transferred to a diffused state. By employing such a constitution, specular reflection from the reflective electrode constituting the EL element 33 can be prevented even in a situation where the EL element 33 is used. Furthermore, since the liquid crystal layer 51 is transferred to a slight diffused state even at the lighted pixel in the EL element 33 so that light from an external light source can be prevented from being regularly reflected from the reflective electrode, excellent display can be obtained.

The transmissive outgoing light 61 from the EL element 33 is changed to colored light by the color filters 45, 46 to go out to the viewer's side. That is, the color filters 45, 46 have both functions to perform coloring of the reflective display using the liquid crystal and perform coloring of the light emission display using the EL element 33.

The ultraviolet cutting film 74 made from a plastic film is provided on the viewer's side of the second substrate 41. The ultraviolet cutting film 74 is useful for preventing degradation of the liquid crystal layer 51 and the EL element 33 due to ultraviolet irradiation and for preventing the second substrate 41 from being damaged.

Thus, in the second embodiment, since a polarizing film is not provided on the second substrate 41 in the liquid crystal display device of a light emitting element incorporated type, bright reflective display can be made possible. Further, when the EL element 33 is utilized, bright light emission display can be made possible. In addition, reflective display of liquid crystal is made possible utilizing the reflective electrode in the organic EL element 33. Coloring is made possible in both of the reflective display and the light emission display by the color filters 45, 46.

In the second embodiment, the EL control switching element 17 and the liquid crystal layer switching element 18 are provided on the first substrate 1 and both the switching elements 17, 18 are covered by the cathode electrode 24 of the EL element 33. Therefore, the switching elements 17, 18 do not block the EL element 33. Accordingly, a bright EL element 33 can be obtained.

In the second embodiment, the EL element 33 emits white light and the white light is changed to light included in a predetermined visible light region by transmitting the color filters 45, 46, so that color display is made possible. By providing the color filters 45, 46 on the side of the second substrate 41, it is made possible to prevent characteristic change of the EL element 33 in a step of providing the color filters 45, 46.

Since a distance between the display electrode 31 and the drain connecting electrode 8 of the liquid crystal layer switching element 18 is increased by providing the color filters between the EL element 33 and the display electrode 31, it becomes difficult to perform electrical connection between the display electrode 31 and the drain connecting electrode 8, but such a problem does not occur in the second embodiment.

Incidentally, in the second embodiment, the example that the scattering type liquid crystal layer having diffusing property during non-application of voltage thereto is utilized as the liquid crystal layer 51 has been explained. However, it is preferable for reducing power consumption during light emission from the EL element 33 that a diffusing type liquid crystal (a normally transmissive scattering type liquid crystal) that is put in a transmissive state during non-application of voltage is utilized as the liquid crystal layer 51. With such a constitution, transmissivity of the liquid crystal layer 51 can be maximized even if a voltage is not supplied to the liquid crystal layer 51 during light emission from the EL element 33. The normally transmissive scattering type liquid crystal utilizes orientation polymer (transparent solid material) and the orientation polymer is arranged regularly in the liquid crystal layer 51 during non-application of voltage, so that a difference in refractive index between the transparent solid material and the liquid crystal is put in a small state.

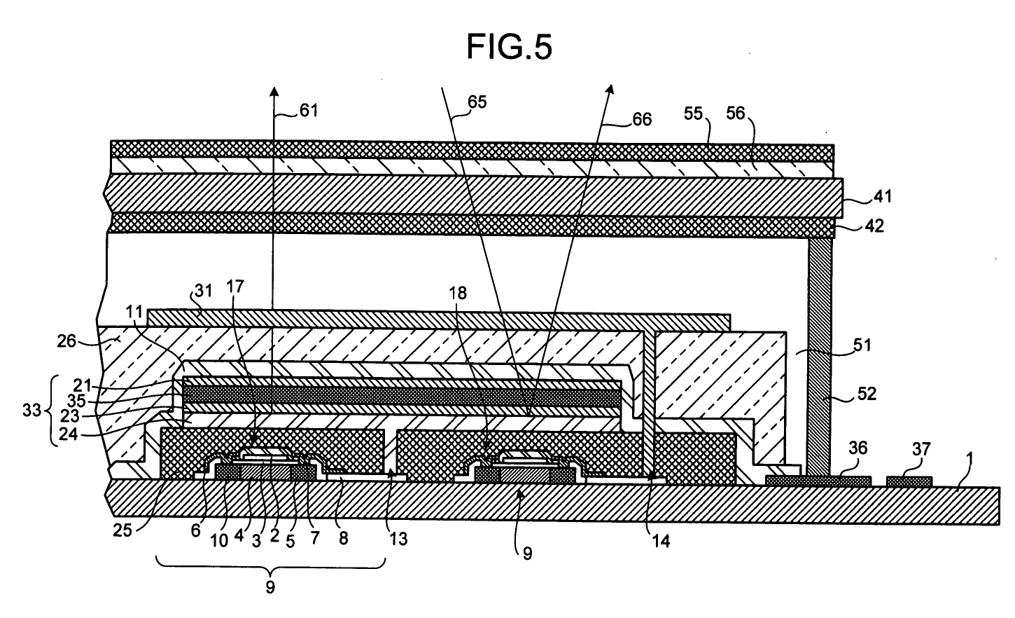

A liquid crystal display device according to a third embodiment is explained below with reference to FIG. 5. A feature of the third embodiment lies in a point that a display electrode is formed on an EL step planarizing film obtained by planarizing an insulating film. FIG. 5 is a partial enlarged sectional view of a portion of the liquid crystal display device in a third embodiment.

The EL control switching element 17 and the liquid crystal layer switching element 18 are provided at each pixel. The passivation film 10 and the interlayer insulating film 25 serving as an insulating film are provided on the switching element 17, 18 like in the first embodiment, and the interlayer insulating film 25 is planarized. Further, an EL element 33 is formed like in the second embodiment.

An insulating film for protection 11 is provided on the EL element 33 to prevent moisture from penetrating the EL element 33 and prevent the EL element 33 from degrading at subsequent steps. To reduce the step occurring due to the switching elements 17, 18, and the EL element 33, an EL step planarizing film 26 made from acrylic resin is provided on the insulating film for protection 11. In the third embodiment, the planarization of the EL step planarizing film 26 is comprehensively performed by performing polishing step after acrylic resin formation. Then, a display electrode 31 is formed on the planarized EL step planarizing film 26.

An LC connecting opening 14 for electrically connecting the drain electrode 7 of the liquid crystal layer switching element 18 and the display electrode 31 constituting a liquid crystal display pixel via the drain connecting electrode 8 is formed in the EL step planarizing film 26. The display electrode 31 is electrically connected to the drain connecting electrode 8 of the liquid crystal layer switching element 18 via the LC connecting opening 14.

Thus, by providing the EL step planarizing film 26, it is made easy to set a clearance between the display electrode 31 and the opposite electrode 42 to be constant. That is, since the a clearance in the liquid crystal layer 51 can be made constant, even if the thickness of the liquid crystal layer 51 is as small as 2 micrometers (μm) to 3 μm, it is made possible to set the liquid crystal layer to an even thickness over a large area.

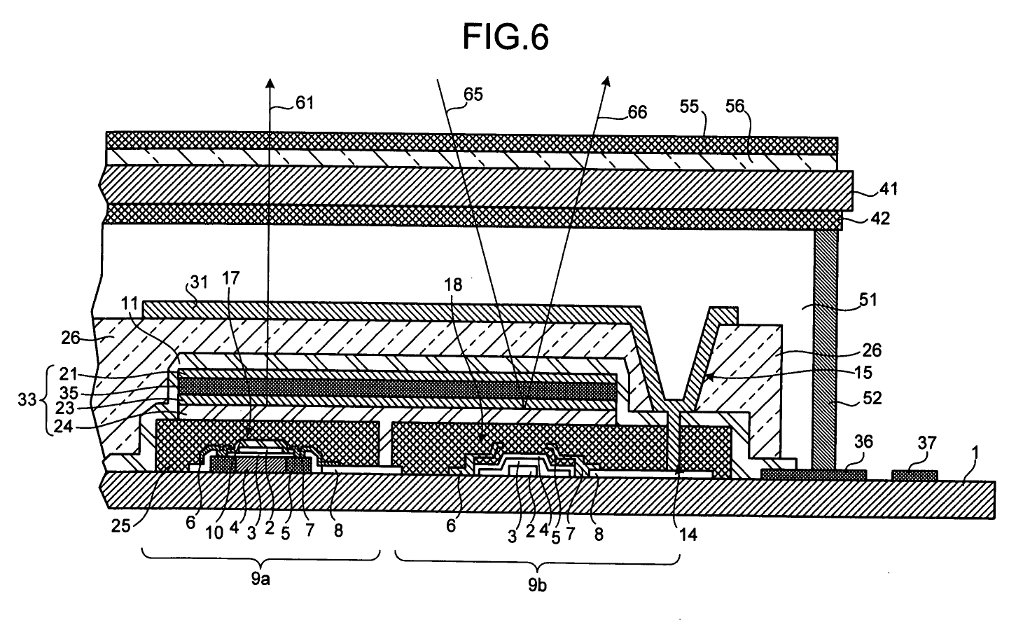

A liquid crystal display device according to a fourth embodiment is explained below with reference to FIG. 6. A feature of the fourth embodiment lies in a point that an EL control switching element is constituted of a poly-silicon thin film transistor including a poly-silicon film as a semiconductor layer, and a liquid crystal layer switching element is constituted of an amorphous silicon thin film transistor including an amorphous silicon (a-Si) film as a semiconductor layer. Another feature of the embodiment lies in a point that an LC connecting inclined opening is provided in an EL step planarizing film that is an insulating film to make connection of the drain connecting electrode of the liquid crystal layer switching element and the display electrode excellent. FIG. 6 is a partial enlarged sectional view of a liquid crystal display device according to the fourth embodiment.

A thin film transistor 9a including a poly-silicon film as a semiconductor layer 4 is provided on the first substrate 1 as the EL control switching element 17. A thin film transistor 9b including an amorphous silicon (a-Si) film as a semiconductor layer 4 is provided as the liquid crystal layer switching element 18. Since the EL element 33 is of a current control type, the semiconductor layer 4 is formed of a poly-silicon film which allows a large amount of current to flow.

Since liquid crystal is of a voltage control type and it is a display element for low power consumption, the semiconductor layer 4 is constituted of the amorphous silicon (a-Si) film with a large OFF resistance. The passivation film 10 and the interlayer insulating film 25 are provided on the switching elements 17, 18 like in the first embodiment, and the interlayer insulating film 25 is planarized. Further, the EL element 33 is formed like in the second embodiment.

An insulating film for protection 11 is provided on the EL element 33 to prevent moisture from penetrating the EL element 33 and prevent the EL element 33 from degrading at subsequent steps. To reduce the step occurring due to the switching elements 17, 18, and the EL element 33, an EL step planarizing film 26 made from acrylic resin is provided on the insulating film for protection 11. The planarization of the EL step planarizing film 26 is comprehensively performed by performing polishing step after acrylic resin formation like in the third embodiment.

The EL step planarizing film 26 must have a film thickness of about 1 μm to 3 μm to planarize the step occurring due to the switching elements 17, 18 and the EL element 33. Therefore, when connection of the display electrode 31 and the drain connecting electrode 8 connecting to the liquid crystal layer switching element 18 is performed, it is difficult to achieve a sufficient step covering performance by only forming an opening (a contact hole) penetrating the EL step planarizing film 26 in the EL step planarizing film 26 serving as the second insulating film for protection simply, which may cause breaking of the display electrode 31. To avoid breaking of the display electrode 31, an LC connecting inclined opening 15 with an inclined sectional shape may be provided on the EL step planarizing film 26. Further, the LC connecting opening 14 is provided in the interlayer insulating film 25. When an area of the opening is made excessively large by forming the LC connecting opening 14 in an inclined sectional shape too, such a constitution can be employed that only the LC connecting inclined opening 15 is formed in a inclined shape.

Thus, the EL element 33 is controlled by the poly-silicon thin film transistor 9a. Then, improvement in controllability of the EL element 33 and evenness of light emitting intensity can be secured by controlling the liquid crystal display element by the amorphous silicon thin film transistor 9b, and simultaneously lower power consumption can be achieved when the liquid crystal display element is driven.

Furthermore, since the surface of the display electrode 31 is almost planarized with the EL step planarizing film 26, orientation stability of the liquid crystal layer 51 can be achieved and a domain can be prevented from occurring. Moreover, by providing the LC connecting inclined opening 15, connection of the display electrode 31 and the drain connecting electrode 8 is stabilized so that improvement in display quality can be achieved.

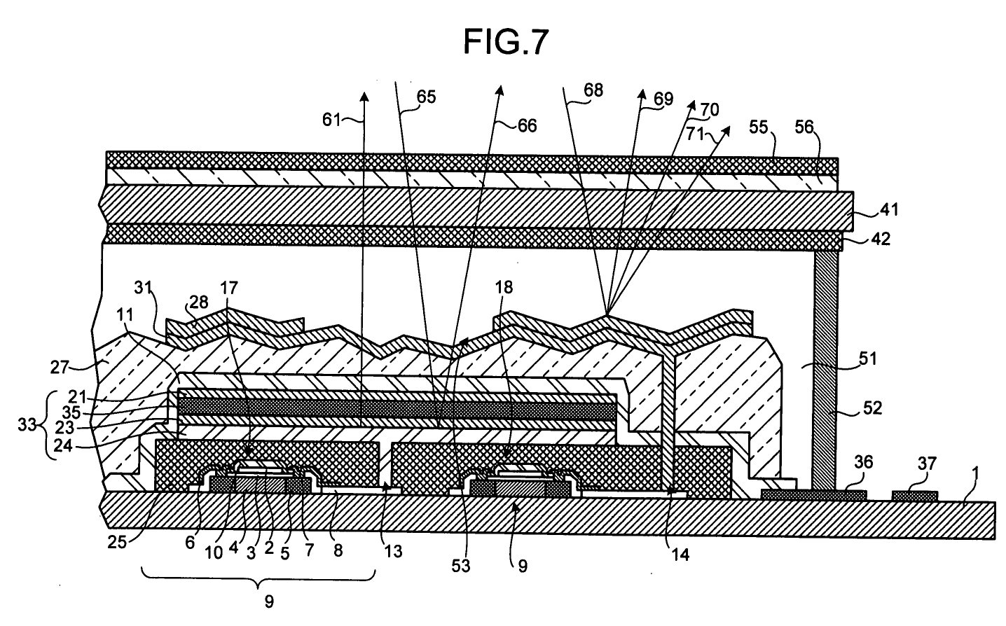

A liquid crystal display device according to a fifth embodiment is explained below with reference to FIG. 7. A feature of the fifth embodiment lies in a point that an undulation is provided on a surface of a display electrode. Another feature of the fifth embodiment lies in a point that a reflective electrode is provided on the display electrode and an opening through which emission light from a light emitting element passes is provided in the reflective electrode. FIG. 7 is a partial enlarged sectional view of a liquid crystal display device according to the fifth embodiment.

The EL control switching element 17 and the liquid crystal layer switching element 18 are provided at each pixel. The passivation film 10 and the interlayer insulating film 25 are provided on the switching elements 17, 18 like in the first embodiment, and the interlayer insulating film 25 is planarized. Further, an EL element 33 is formed like in the second embodiment.

An insulating film for protection 11 is provided on the EL element 33 to prevent moisture from penetrating the EL element 33 and prevent the EL element 33 from degrading at subsequent steps. An undulated interlayer insulating film 27 having undulation on a surface thereof is forming on the insulating film for protection 11 using photo-curing resin for the purpose of reducing water permeability to the EL element 33 and forming undulation on the surface of the display electrode. An LC connecting opening 14 for electrically connecting the drain electrode 7 of the liquid crystal layer switching element 18 and the display electrode 31 constituting a liquid crystal display pixel via the drain connecting electrode 8 is formed in the undulated interlayer insulating film 27.

A display electrode 31 made from a transparent electric conductive film is provided on the undulated interlayer insulating film 27. The display electrode 31 is electrically connected to the drain connecting electrode 8 of the liquid crystal layer switching element 18 via the LC connecting opening 14. A reflective electrode 28 made of an aluminum film and having a transmissive opening 53 through which emission light from the EL element 33 is transmitted is provided on a portion of the display electrode 31. When reflection is conducted by the cathode electrode 24, there may be a case that the light emitting layer 23 of the EL element 33, an electron transporting layer (not shown), or the like results in coloring. In such a case, by providing the reflective electrode 28 in the vicinity of the liquid crystal layer 51 like in the fifth embodiment, substantially equal reflection is made possible in a visible light region, so that white color displaying is made possible.

An opposite electrode 42 made of a transparent electric conductive film is provided on a face of the liquid crystal layer 51 side of the second substrate 41 opposed to the first substrate 1. The first substrate 1 and the second substrate 41 are spaced by a predetermined clearance through a sealing member 52 and a spacer (not shown). The liquid crystal layer 51 is sealed in the clearance between the first substrate 1 and the second substrate 41. A crossing point of the display electrode 31 and the reflective electrode 28, and the opposite electrode 42 constitutes a liquid crystal display pixel.

An optical compensator 56 and a polarizing film 55 are provided on a face of the second substrate 41 opposed from the liquid crystal layer 51 in this order from the second substrate 41. An input electrode 37 that connects the connecting electrode 36 mounted with a driving circuit unit (not shown) and an external circuit applying a predetermined signal to the driving circuit unit is provided on the first substrate 1 to apply a predetermined signal to the gate electrode or the source electrode.

Transmissive outgoing light 61 from the EL element 33 goes out of the trasnmissive opening 53 provided in the reflective electrode 28 toward the second substrate 41. Light of the outgoing light from the EL element 33 that has been shielded by the reflective electrode 28 goes out of the transmissive opening 53 of the reflective electrode 28 through repetition of reflection from the reflective electrode 28 provided on the undulated interlayer insulating film 27 in various directions and reflection from the cathode electrode 24 of the EL element 33 which is a reflective electrode.

One reflection incoming light 65 from an external light source of the liquid crystal display device is reflected by the cathode electrode 24 of the EL element 33 and optically modulated by the liquid crystal layer 51 to go out toward a viewer as reflection outgoing light 66. Another reflection incoming light 68 from an external light source is reflected by the reflective electrode 28 provided on the undulated interlayer insulating film 27 to go out in various direction as reflection outgoing lights 69, 70, 71.

Thus, as well as providing the EL control switching element 17 and the liquid crystal layer switching element 18 on the first substrate 1 to control the EL element 33 and the liquid crystal display element, it is made possible to make reflective display by the liquid crystal display element bright or achromatic color (white color) display by providing the undulated interlayer insulating film 27 on the EL element 33 to produce a structure performing reflection in various direction at the reflective electrode 28 and providing the transmissive opening 53 in the reflective electrode 28.

Furthermore, since emission light from the EL element 33 can go out through the transmissive opening 53 of the reflective electrode 28, and reflection caused by the reflective electrode 28 having an undulated shape is utilized, bright display can be made possible.

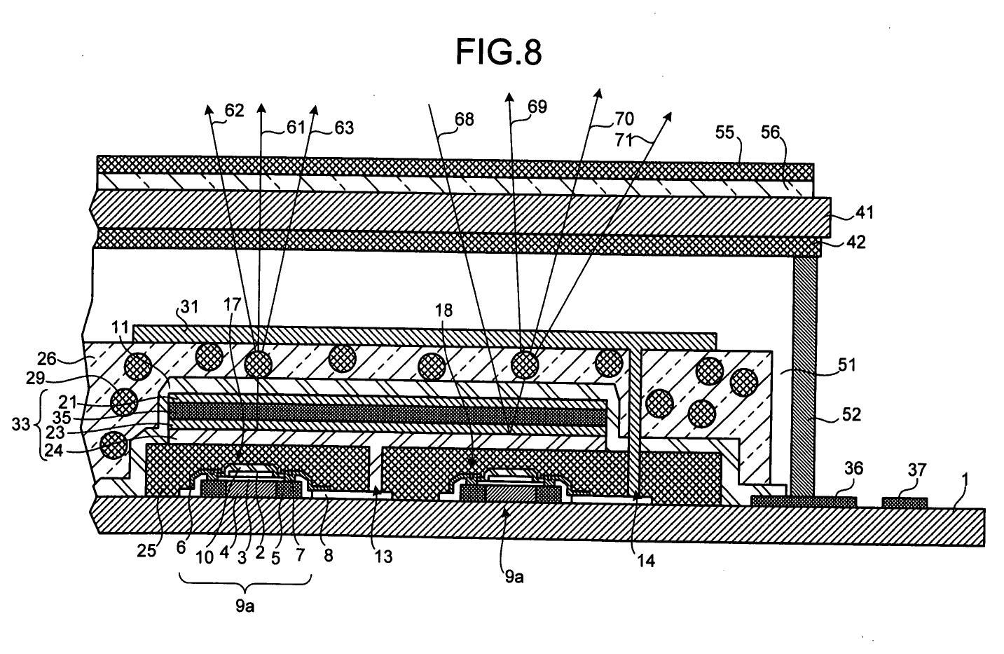

A liquid crystal display device according to a sixth embodiment is explained below with reference to FIG. 8. A feature of the sixth embodiment lies in a point that a diffusing member is added within the EL step planarizing film provided on the switching element to give light diffusion property to the EL step planarizing film. FIG. 8 is a partial enlarged sectional view of a liquid crystal display device according to the sixth embodiment.

The EL control switching element 17 and the liquid crystal layer switching element 18 are formed on the first substrate 1 using poly-silicon thin film transistors 9a. The passivation film 10 and the interlayer insulating film 25 are provided on the switching elements 17, 18 like in the first embodiment, and the interlayer insulating film 25 is planarized. Further, an EL element 33 is formed like in the second embodiment.

An insulating film for protection 11 is provided on the EL element 33 to prevent moisture from penetrating the EL element 33 and prevent the EL element 33 from degrading at subsequent steps. To reduce the step occurring due to the switching elements 17, 18, and the EL element 33, an EL step planarizing film 26 made from acrylic resin is provided on the insulating film for protection 11. Acrylic resin and diffusion members 29 formed of transparent balls made from stainless steel different in refraction index from the acrylic resin are mixed in the EL step planarizing film 26. The EL step planarizing film 26 has a light diffusing function, because light is reflected on interfaces between the acrylic resin and diffusing members 29 and the reflection is repeated in a close range plural times.

An LC connecting opening 14 for electrically connecting the drain electrode 7 of the liquid crystal layer switching element 18 and the display electrode 31 constituting a liquid crystal display pixel via the drain connecting electrode 8 is formed in the EL step planarizing film 26. The display electrode 31 is electrically connected to the drain connecting electrode 8 of the liquid crystal layer switching element 18 via the LC connecting opening 14.

An opposite electrode 42 made from a transparent electric conductive film is provided on a liquid crystal layer 51 side face of the second substrate 41 that is spaced from the first substrate 1 by a predetermined clearance and is adhered thereto by a sealing material 52. The liquid crystal layer 51 is sealed in the clearance between the first substrate 1 and the second substrate 41. An optical compensator 56 and a polarizing film 55 are provided on a face of the second substrate 41 opposed from the liquid crystal layer 51 in this order from the side of the second substrate 41. An input electrode 37 that connects the connecting electrode 36 mounted with a driving circuit unit (not shown) and an external circuit applying a predetermined signal to the driving circuit unit is provided on the first substrate 1 to apply a predetermined signal to the gate electrode or the source electrode.

Outgoing light from the EL element 33 is scattered in various directions by the diffusing members 29 in the EL step planarizing film 26 to form transmissive outgoing lights 61, 62, 63 in various directions. Reflection incoming light 68 from an external light source of the liquid crystal display device is reflected by the cathode electrode 24 of the EL element 33 and optically modulated by the liquid crystal layer 51, and is further scattered by the diffusing members 29 to form reflection outgoing lights 69, 70, 71 in various directions.

Thus, diffusion property can be given to the liquid crystal display device by the diffusion members 29 contained in the EL step planarizing film 26. Light from the EL element 33 can be diffused.

In the sixth embodiment, though only the optical compensator 56 is interposed between the second substrate 41 and the polarizing film 55, when diffusing property obtained by only diffusing members 29 contained in the EL step planarizing film 26 is insufficient, a diffusing layer may be provided between the second substrate 41 and the optical compensator 56 or between the optical compensator 56 and the polarizing film 55.

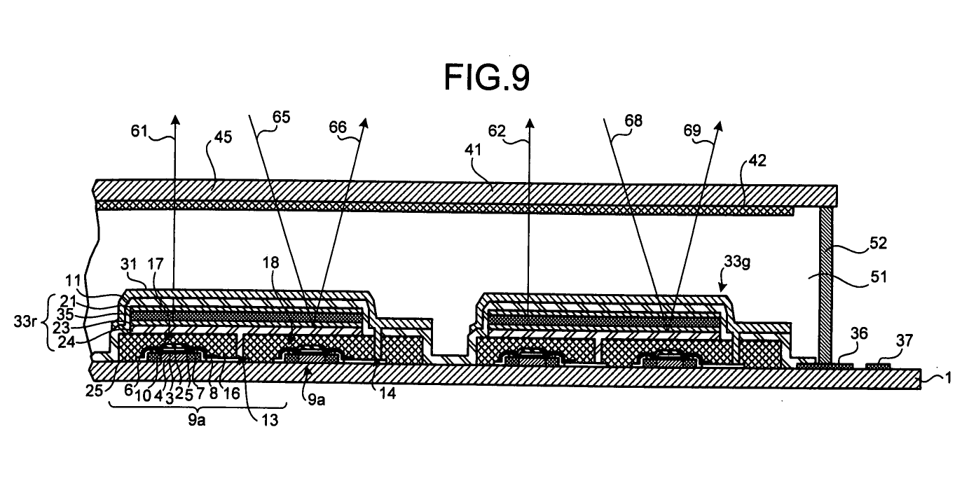

A liquid crystal display device according to a seventh embodiment is explained below with reference to FIG. 9. A feature of the seventh embodiment lies in a point that there is light absorption on a light emitting layer in an EL element, transmissive light is colored, and light emitting color is colored, and the EL element is constituted of a plurality of kinds of EL elements emitting different colors, respectively. FIG. 9 is a partial enlarged sectional view of a liquid crystal display device according to the seventh embodiment.

The EL control switching element 17 and the liquid crystal layer switching element 18 are formed on the first substrate 1 using poly-silicon thin film transistors 9a. The passivation film 10 and the interlayer insulating film 25 are provided on the switching elements 17, 18 like in the first embodiment, and the interlayer insulating film 25 is planarized.

A cathode electrode 24 constituted of a reflective metal electrode is formed on the interlayer insulating film 25 using alloy of silver and magnesium. In an EL element 33r for red light emission, an electron transporting layer (not shown) made from quinolinolenic aluminum complex (Alq), a light emitting layer 23 made from europium (Eu) complex, a hole transporting layer 35 made from triphenylamine derivative (TPD), and an anode electrode 21 made from indium tin oxide (ITO) film as a transparent electric conductive film are stacked on the cathode electrode 24 in this order. Transmissive outgoing light 61 from the EL element 33r for red light emission becomes red.

In an EL element 33g for green light emission, an light emitting layer 34 made from terbium (Tb) complex is used on the cathode electrode 24 instead of the light emitting layer 23 made from europium (Eu) complex of the EL element 33r for red color light emission. Transmissive outgoing light 62 from the EL element 33g for green light emission becomes green. In FIG. 9, the EL element 33r for red light emission and the light emitting layer 23, and the EL element 33g for green light emission and the light emitting layer 34 are shown. Though not illustrated in FIG. 9, a light emitting layer made from triphenylamine derivative (TPD) is used in an EL element for blue light emission. Transmissive outgoing light from the EL element for blue light emission becomes blue. By arranging the respective EL elements 33r, 33g for red light emission, green light emission, and blue light emission on a display region in a matrix manner, color display is made possible.

An insulating film for protection 11 made of a silicon oxide film is provided on the respective EL elements 33r, 33b for red light emission, green light emission, and blue light emission to prevent moisture from permeating into the EL elements 33r, 33g. A display electrode 31 made from a transparent electric conductive film is provided on the insulating film for protection 11. By providing an LC connecting opening 14 in the insulating film for protection 11 and the interlayer insulating film 25, the display electrode 31 and the drain connecting electrode 8 of the switching element for liquid crystal film control are electrically connected to each other via the LC connecting opening 14.

It is further desirable to form a moisture permeation preventing film (not shown) made of a silicon nitride film, a tantalum oxide film, or a silicon oxide film on the display electrode 31 to prevent permeation of moisture or the like at a portion of the LC connecting opening 14. It is preferable that the moisture permeation preventing film is a thin film with a large dielectric constant. A structure is effective that the moisture permeation preventing film is provided on an overlapping portion of the LC connecting opening 14 and the display electrode 31 and around the same, but a structure is desirable in view of reliability that the moisture permeation preventing film is provided on the whole face of the display electrode 31 to prevent water permeation from a portion of the display electrode 31 on which the moisture permeation preventing film is not provided.

In FIG. 9, the LC connecting opening 14 has been shown very near the EL elements 33r, 33g, but it is actually provided away from the EL elements 33r, 33g at a distance of about 30 μm to 100 μm. This is for preventing moisture from entering in the EL elements 33r, 33g from the LC connecting opening 14.

An opposite electrode 42 covering a plurality of display electrodes 31 arranged in a matrix manner is provided on a face of the second substrate 41 opposed to the first substrate 1 with a predetermined clearance, the face being positioned on the side of the liquid crystal layer 51. A crossing portion of the display electrode 31 and the opposite electrode 42 constitutes a liquid crystal display pixel. An orientation film (not shown) for arranging liquid crystal molecules in a predetermined direction is provided on a face of the first substrate 1 or the second substrate 41 facing the liquid crystal layer 51.

A twist nematic (TN) liquid crystal layer 51 having a twist angle in a range of 60 degree to 70 degree is sealed in the clearance between the opposite electrode 42 and the display electrode 31. Under a bright external environment, reflection incoming light 65 from external light is elliptically polarized by the polarizing film 55 and the optical compensator 56 and modulated depending on a voltage applied to the liquid crystal layer 51 to reach the cathode electrode 24 that is the reflective electrode in the EL element 33r for red light emission. Then, the light is polarized in a reversely twisted manner by the reflective electrode to pass through the liquid crystal layer 51 again and pass through the optical compensator 56 and the polarizing film 55 and is emitted to the viewer's side as reflection outgoing light 66. The reflection outgoing light 66 is changed to red outgoing light by the light emitting layer 23 constituting the EL element 33r for red light emission.

Another reflection incoming light 68 is elliptically polarized by the polarizing film 55 and the optical compensator 56, and is modulated depending on a voltage applied to the liquid crystal layer 51 to reach the cathode electrode 24 that is a reflective electrode in the EL element 33g for green light emission. Then, the light is polarized in a reversely twisted manner by the reflective electrode to pass through the liquid crystal layer 51 again and pass through the optical compensator 56 and the polarizing film 55 and is emitted to the viewer's side as reflection outgoing light 69. The reflection outgoing light 69 is changed to green outgoing light by the light emitting layer 34 constituting the EL element 33g for green light emission.

Still another reflection incoming light is reflected by a cathode electrode in an EL element for blue light emission that is not illustrated in FIG. 9 to go out to the viewer's side as reflection outgoing light. The reflection outgoing light is changed to blue outgoing light by the light emitting layer constituting the EL element for blue light emission. Thus, by utilizing absorption of the reflection incoming lights in specific wavelength regions thereof at times of transmissions of the reflection incoming lights through the light emitting layers 23, 34 in the respective EL elements 33r, 33g for red light emission, green light emission, and blue light emission, color reflective display is made possible.

On the other hand, under a dark external environment, since the liquid crystal layer 51 serving as a light receiving element is dark at bright display, it becomes difficult to recognize lights and darks, so that the respective EL elements 33r, 33g for red light emission, green light emission, and blue light emission are lighted. At that time, to achieve such setting that lights emitted from the respective EL elements 33r, 33g for red light emission, green light emission, and blue light emission are hardly absorbed in the liquid crystal layer 51 and retardation hardly occurs in the liquid crystal layer 51, a voltage reducing retardation, namely, a large voltage is applied to the liquid crystal layer 51.

Further, under a dark external environment, such a constitution can be employed to achieve low power consumption as much as possible that the liquid crystal display element is of normally white type where it becomes transparent during non-application of voltage and a signal is not applied to the liquid crystal layer switching element 18 that drives the liquid crystal layer 51. Further, providing the polarizing film 55 and the optical compensator 56 is also desirable for preventing reflection from the cathode electrode 24 efficiently under a bright external environment.

Thus, the constitution that the EL control switching element 17 and the liquid crystal layer switching element 18 are provided on the first substrate 1 and both the switching elements 17, 18 are covered by the cathode electrodes 24 in the respective EL elements 33r, 33g is employed in the seventh embodiment. Therefore, the switching elements 17, 18 do not block the EL elements 33r, 33g. Accordingly, bright EL elements can be obtained.

By utilizing absorption characteristics of specific wavelengths of the light emitting layers 23, 34 constituting the EL elements 33r, 33g and the cathode electrode 24 serving as the reflective electrode, color display can be achieved when a liquid crystal display element utilizing the liquid crystal layer 51 is caused to function. Since color display is performed by utilizing the light emitting layers 23, 34 that perform light emission with specific wavelengths, for example, red color, green color, and blue color to light emission of the EL elements 33r, 33g, brighter display is made possible as compared with a case where color filters are utilized.

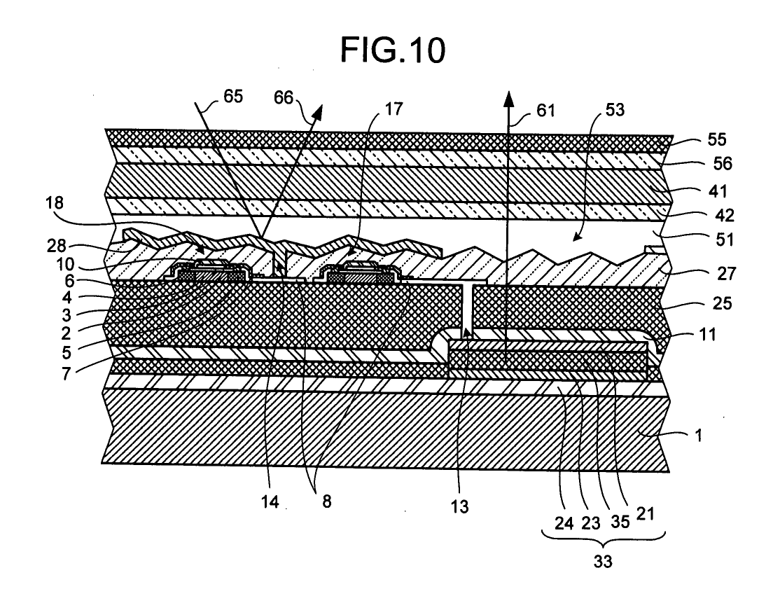

A liquid crystal display device according to an eighth embodiment is explained below with reference to FIG. 10. A feature of the eighth embodiment lies in a point that the EL element is formed on the first substrate and the EL control switching element and the liquid crystal layer switching element are provided on the EL element. FIG. 10 is a partial enlarged sectional view of a liquid crystal display device according to the eighth embodiment.

A cathode electrode 24 made of a reflective metal electrode of a third electrode is formed from alloy of aluminum and magnesium on the first substrate 1. An electron transporting layer (not shown) made from quinolinolenic aluminum complex (Alq), a light emitting layer 23 made of quinolinolenic aluminum complex doped with quinacridone, a hole transporting layer 35 made from triphenylamine derivative, and an anode electrode 21 of a fourth electrode made from indium tin oxide (ITO) film as a transparent electric conductive film are stacked on the cathode electrode 24 in this order. The EL element 33 is constituted of constitutions from the cathode electrode 24 to the anode electrode 21.

An insulating film for protection 11 made from a silicon oxide film is provided on the EL element 33 to prevent moisture from penetrating the EL element 33. An interlayer insulating film 25 made from a silicon nitride film is provided on the insulating film for protection 11 to reduce a step due to the EL element 33 and prevent moisture from penetrating the EL element 33.

An EL control switching element 17 made of a poly-silicon thin film transistor that controls the EL element 33 and a liquid crystal layer switching element 18 that controls the liquid crystal display element are provided on the interlayer insulating film 25. A drain connecting electrode 8 connecting to the EL control switching element 17 is electrically connected to an anode electrode 21 of the EL element 33 via an EL connecting opening 13 provided in the interlayer insulating film 25 and the insulating film for protection 11.

An undulated interlayer insulating film 27 is formed on both the switching elements 17, 18. A reflective electrode 28 made of an aluminum film is formed on the undulated interlayer insulating film 27. A transmissive opening 53 is provided in a portion of the reflective electrode 28 positioned on the EL element 33, and transmissive outgoing light 61 from the EL element 33 is emitted from the transmissive opening 53. The reflective electrode 28 is electrically connected to the drain connecting electrode 8 in the liquid crystal layer switching element 18 via an LC connecting opening 14 provided in the undulated interlayer insulating film 27. The drain connecting electrode 8 in the liquid crystal layer switching element 18 is electrically connected to the drain electrode 7 in the liquid crystal layer switching element 18.

Thus, the EL element 33 is first formed on the first substrate 1, and the EL element 33 is firmly protected by a film with reduced moisture and gas penetration thereto. Therefore, degradation of the EL element 33 at subsequent steps can be prevented. Further, since the EL element 33 can be formed on a glass substrate, such a problem that the switching elements 17, 18 are damaged does not occur even of a mask for mask vapor deposition comes in contact with the substrate.

Further, since the switching elements 17, 18 are formed on the interlayer insulating film 25, characteristic change or degradation of the switching elements 17, 18 does not occur at a step of forming the EL element. Moreover, after the EL element 33 and the switching elements 17, 18 are formed, the EL connecting opening 13 is formed and the drain connecting electrode 8 is formed in the same vacuum chamber, so that pollution from the EL connecting opening 13 to the EL element 33 can be reduced to an almost negligible extent.

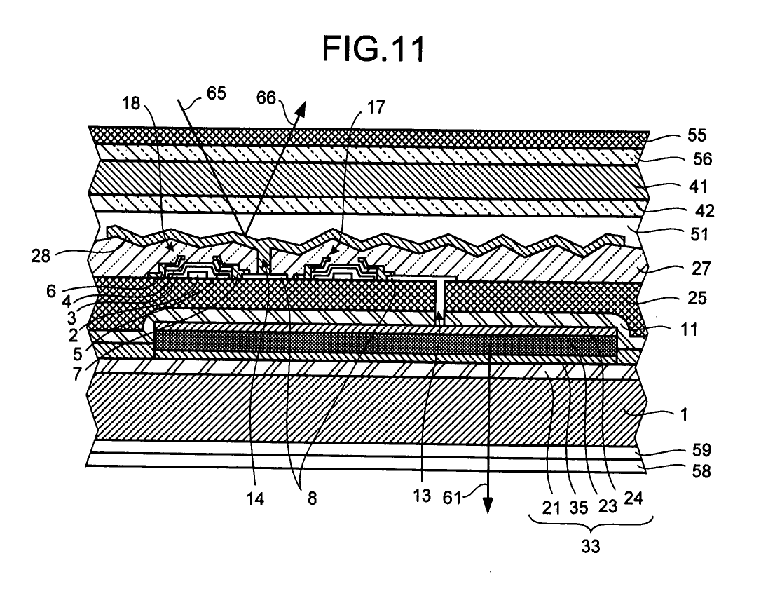

A liquid crystal display device according to a ninth embodiment is explained below with reference to FIG. 11. A feature of the ninth embodiment lies in a point that the EL element is formed on the first substrate and the EL control switching element and the liquid crystal layer switching element are provided on the EL element. Another feature lies in a point that light emission display according to an EL element is performed on a face opposed from a face on which reflective display is performed by a liquid crystal display element. FIG. 11 is a partial enlarged sectional view of a liquid crystal display device according to the ninth embodiment.

An anode electrode 21 of a fourth electrode made of an indium tin oxide (ITO) film is formed on the first substrate 1 as a transparent electric conductive film. A hole transporting layer 35 made from triphenylamine derivative, a light emitting layer 23 made of quinolinolenic aluminum complex doped with quinacridone, and an electron transporting layer (not shown) made from quinolinolenic aluminum complex (Alq) are formed on the anode electrode 21 in this order. A cathode electrode 24 made from a reflective metal electrode of a third electrode is formed on the electron transporting layer from alloy of aluminum and magnesium. The EL element 33 is constituted of constitutions positioned from the anode electrode 21 to the cathode electrode 24.

An insulating film for protection 11 made from a silicon oxide film is provided on the EL element 33 to prevent moisture from penetrating the EL element 33. An interlayer insulating film 25 made from a silicon nitride film is provided on the insulating film for protection 11 to reduce a step due to the EL element 33 and prevent moisture from penetrating the EL element 33.

An EL control switching element 17 that controls the EL element 33 and a liquid crystal layer switching element 18 that controls the liquid crystal display element are provided on the interlayer insulating film 25. The EL control switching element 17 and the liquid crystal layer switching element 18 are constituted of amorphous silicon thin film transistors including an amorphous silicon (a-Si) film as a semiconductor layer. Since the amorphous silicon thin film transistor can be manufactured at a low temperature manufacturing step, it is suitable to be formed on an organic EL element 33 via the insulating film for protection 11 and the interlayer insulating film 25. The drain connecting electrode 8 connecting to the EL control switching element 17 is electrically connected to the cathode electrode 24 in the EL element 33 via an EL connecting opening 13 provided in the interlayer insulating film 25 and the insulating film for protection 11.

An undulated interlayer insulating film 27 is formed on both the switching elements 17 and 18. A reflective electrode 28 made of an aluminum film is formed on the undulated interlayer insulating film 27. A first optical compensator 56 and a first polarizing film 55 are stacked on a face of the second substrate 41 opposed from the liquid crystal layer 51. Reflection incoming light 65 incident from the side of the second substrate 41 passes through the liquid crystal layer 51 to be reflected by the reflective electrode 28 and the reflective light passes through the liquid crystal layer 51 again to go out of the second substrate 41 (reflection outgoing light 66).

Emission light from the EL element 33 transmits the first substrate 1 to go out downwardly in FIG. 11 (transmissive outgoing light 61). A second optical compensator 59 and a second polarizing film 58 are stacked on a face of the first substrate 1 opposed from the liquid crystal layer 51.

When the liquid crystal display device according to the ninth embodiment explained above is applied to a color display device, the following constitutions can be employed. When reflective display performed by a liquid crystal display element is colored, for example, a constitution having color filters can be adopted like in the liquid crystal display device according to the second embodiment described above. Further, when light emission display performed by the EL element 33 is colored, a constitution where color filters are provided on the first substrate 1 can be adopted or a constitution where an EL element emitting color light is used like in the liquid crystal display device according to the seventh embodiment described above.

Moreover, reflective display performed by the liquid crystal display element can be observed from the side of the second substrate 41, while light emission display performed by the EL element 33 can be observed on the side of the first substrate 1. That is, in the ninth embodiment, duplex displaying can be made possible. Since it is unnecessary to provide a transmissive opening for transmissive outgoing light from the EL element 33 in the reflective electrode 28, the reflective electrode 28 can be formed to have a large area, which allows bright displaying. Furthermore, since a switching element or a reflective electrode for blocking transmissive outgoing light from the EL element 33 is not provided, displaying based upon light emission from the EL element 33 can be performed efficiently.

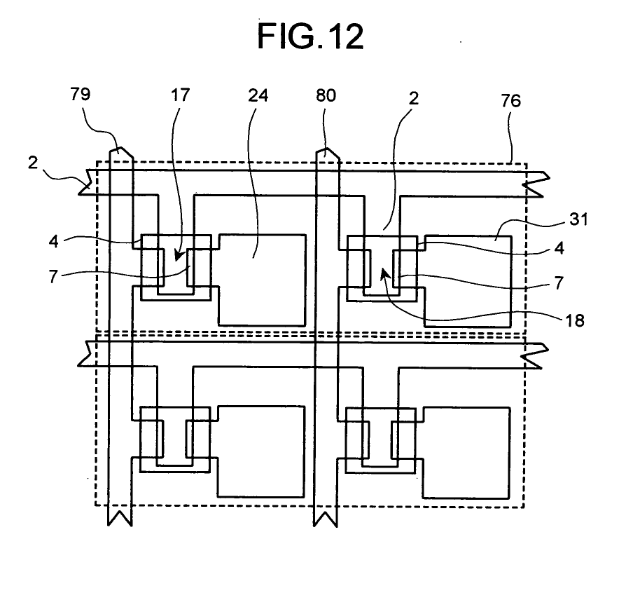

A liquid crystal display device according to a tenth embodiment is explained below with reference to FIGS. 12, 13, and 14. FIGS. 12, 13, and 14 are illustrative plan views showing three examples different in plane arrangement of an EL control switching element and a liquid crystal layer switching element.

As the first example, as shown in FIG. 12, an EL control switching element 17 and a liquid crystal layer switching element 18 are provided with source electrodes. As the source electrode, two kinds of a first source electrode 79 and a second source electrode 80 are wired. In the example shown in FIG. 12, the first source electrode 79 is for the EL control switching element 17, while the second source electrode 80 is for the liquid crystal layer switching element 18. A display pixel region 76 is constituted of a region having a display electrode 31 for one liquid crystal display element and an EL element constituting electrode constituted of either one of one cathode electrode 24 or one anode electrode 21.

Each of switching elements 17, 18 is constituted of a source electrode 79, 80, a semiconductor layer 4 made from an amorphous silicon film or poly-silicon film, a drain electrode 7, an impurity-doped semiconductor region 5 (not shown), a gate insulating film 3 (not shown), a gate electrode 2, and a drain connecting electrode 8 (not shown) connecting to the drain electrode 7. Although not illustrated in FIG. 12, the drain connecting electrode 8 connecting to the EL control switching element 17 is connected to the anode electrode 21 or the cathode electrode 24 for the EL element 33. The drain electrode 8 of the liquid crystal layer switching element 18 is connected to the display electrode 31 or the reflective electrode 28.

Thus, the EL control switching element 17 and the liquid crystal layer switching element 18 on the same display pixel region are connected to different source electrodes 79, 80. Different currents are required for the EL element 33 and the liquid crystal display element, and voltages applied between the source electrodes 79, 80 and the drain electrode 7 are different from each other. Accordingly, as shown in FIG. 12, a constitution where the EL control switching element 17 and the liquid crystal layer switching element 18 are connected to different source electrodes 79, 80 is excellent in controllability, which is desirable.

In the example shown in FIG. 12, since the gate electrode 2 is common to the EL control switching element 17 and the liquid crystal layer switching element 18, an area occupied by the gate electrode 2 can be reduced as compared with a case that gate electrodes are individually provided for the EL control switching element 17 and the liquid crystal layer switching element 18.

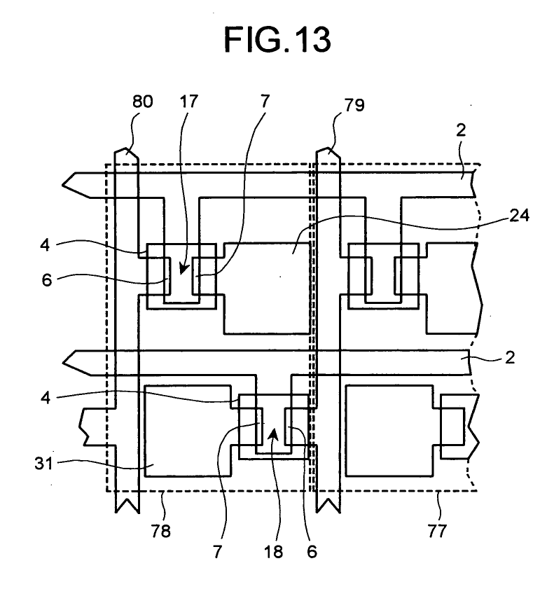

A feature of the second example shown in FIG. 13 lies in a point that switching elements connected to a gate electrode are different in display pixel regions contiguous to each other. As shown in FIG. 13, an EL control switching element 17 is arranged on a depth side on the figure in a left side display pixel region 78 described on the left side on the figure, while an EL control switching element 17 is arranged on a front side of the figure in a right side display pixel region 77 described on the right side in FIG. 13.

Arrangement of liquid crystal layer switching elements 18 is reversed to that of the EL control switching elements 17. That is, in FIG. 13, the liquid crystal layer switching element 18 is arranged on the front side on the figure in the left side display pixel region 78 described on the left side in FIG. 13, while the liquid crystal layer switching element 18 is arranged on the depth side on the figure in the right side display pixel region 77 described on the right side in FIG. 13.

The EL control switching element 17 for the right side display pixel region 77 is connected to a first source electrode 79. The EL control switching element 17 for the left side display pixel region 78 is connected to a second source electrode 80. The liquid crystal layer switching element 18 for the left side display pixel region 78 is connected to a first source electrode 79. The liquid crystal layer switching element 18 for the right side display pixel region 77 is connected to the second source electrode 80 that is not shown in FIG. 13. The EL control switching element 17 for the right side display pixel region 77 and the EL control switching element 17 for the left side display pixel region 78 are connected to the same gate electrode 2. The liquid crystal layer switching element 18 for the right side display pixel region 77 and the liquid crystal layer switching element 18 for the left side display pixel region 78 are connected to the same gate electrode 2. However, the EL control switching element 17 and the liquid crystal layer switching element 18 on the same display pixel region are connected to different gate electrodes 2. Such an arrangement is repeated.

That is, though not illustrated, the EL control switching element 17 is connected to the second source electrode 80 and the liquid crystal layer switching element 18 is connected to the first source electrode 79 in a display pixel region on the right side of the right side display pixel region 77 (corresponding to the left side display pixel region 78). Though not illustrated, the EL control switching element 17 is connected to the first source electrode 79 and the liquid crystal layer switching element 18 is connected to the second source electrode 80 in a display pixel region on the left side of the left side display pixel region 78 (corresponding to the right side display pixel region 77).

Accordingly, even in the example shown in FIG. 13, the EL control switching element 17 and the liquid crystal layer switching element 18 on the same display pixel region are connected to different source electrodes 79, 80. The EL element 33 and the liquid crystal display element require different currents, and voltages applied between the source electrodes 79, 80 and the drain electrode 7 are different from each other. Therefore, as shown in FIG. 13, a constitution where the EL control switching element 17 and the liquid crystal layer switching element 18 are connected to different source electrodes 79, 80 is excellent in controllability, which is desirable.

When such a constitution is employed that source electrodes for the EL control switching elements 17 and source electrodes for the liquid crystal layer switching elements 18 are individually wired for respective display pixel regions 77, 78, the number of wires for the source electrodes becomes double, so that a wire breaking probability is increased and characteristic degradation of the EL element 33 is caused due to increase in number of overlaps of the EL element 33 and wires when an area of the EL element 33 is enlarged. According to the example shown in FIG. 13, occurrence of such an inconvenience can be avoided.

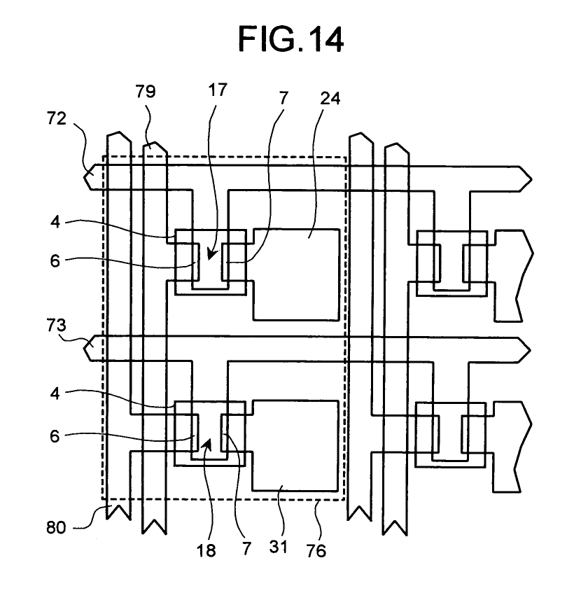

A the third example of a plane arrangement will be explained. The example shown in FIG. 14 has such a feature that source electrodes and gate electrodes are individually provided for an EL control switching element and a liquid crystal layer switching element to achieve low power consumption. An EL control switching element 17 is connected to a first source electrode 79 and a first gate electrode 72. A liquid crystal layer switching element 18 is connected to a second source electrode 80 and a second gate electrode 73.

Such a constitution may be employed that the first source electrode 79 and the second source electrode 80 are formed in a stacked structure via an insulating layer, for example, the first source electrode 79 is formed from source electrode material, the second source electrode 80 is formed from gate electrode material, and an interlayer insulating film is provided between the first source electrode 79 and the second source electrode 80. It is possible to employ a stacked structure of the first gate electrode 72 and the second gate electrode 73. In particular, a two-layer wiring can be made possible at a crossing portion of the source electrode 79, 80 and the gate electrode 72, 73 by forming an opening in an insulating film positioned around the crossing point and performing arrangement conversion between upper and lower source electrodes and a data electrode.

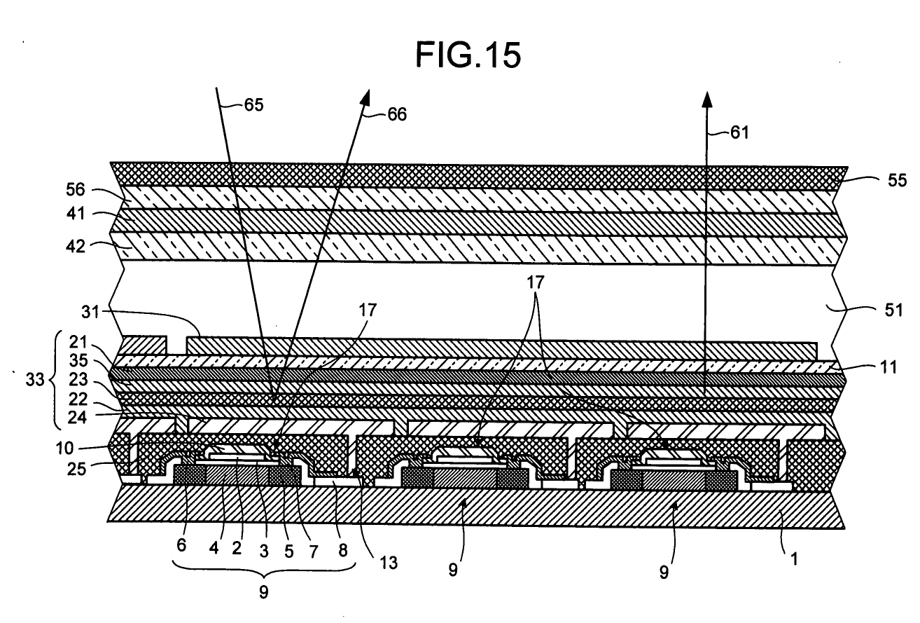

A liquid crystal display device according to an eleventh embodiment is explained below with reference to FIG. 15. A feature of the eleventh embodiment lies in a point that an EL element and a switching element for controlling the EL element are incorporated in a passive matrix type liquid crystal display panel. Therefore, in the liquid crystal display device according to the eleventh embodiment, a liquid crystal layer switching element is not provided. FIG. 15 is a partial enlarged sectional view of a liquid crystal display device with a light emitting element incorporated according to the eleventh embodiment of the present invention.

As shown in FIG. 15, a thin film transistor 9 made of a poly-silicon film is provided on the first substrate 1. The thin film transistor 9 is an EL control switching element 17 that controls an EL element 33. To prevent characteristic of the thin film transistor 9 from changing at a light emitting element forming step or a liquid crystal display paneling step conducted later, a passivation film 10 is formed on the thin film transistor 9. The drain electrode 7 is electrically connected to the drain connecting electrode 8.

An interlayer insulating film 25 that is an insulating film is provided on the thin film transistor 9 and the passivation film 10 to be planarized. An EL connecting opening 13 for electrically connecting the drain electrode 7 of the EL control switching element 17 and the cathode electrode 24 of the EL element 33 via the drain connecting electrode 8 is formed in the interlayer insulating film 25.

A cathode electrode 24 that is a reflective metal electrode serving as a third electrode is formed from alloy of aluminum and magnesium on the interlayer insulating film 25. An electron transporting layer 22 made from quinolinolenic aluminum complex (Alq), a light emitting layer 23 made of quinolinolenic aluminum complex doped with quinacridone, a hole transporting layer 35 made from triphenylamine derivative, and an anode electrode 21 of a fourth electrode made from indium tin oxide (ITO) film as a transparent electric conductive film are stacked on the cathode electrode 24 in this order. The EL element 33 is constituted of constitutions from the cathode electrode 24 to the anode electrode 21.

An insulating film for protection 11 made of an insulating film such as a silicon oxide film is provided on the EL element 33 for preventing moisture penetration into the EL element 33. A stripe-like display electrode 31 made from indium tin oxide (ITO) film is provided on the insulating film for protection 11 as a transparent electric conductive film for driving a liquid crystal.

The second substrate 41 is opposed to the first substrate 1 to be spaced to each other with a predetermined clearance. A stripe-like opposite electrode 42 extending in a direction approximately orthogonal to the display electrode 31 is provided on a face of the second substrate 41 positioned on the side of the liquid crystal layer 51. A crossing portion of the display electrode 31 and the opposite electrode 42 is a liquid crystal display pixel. An orientation film (not shown) that arranges liquid crystal molecules in a predetermined direction is provided on a face of the first substrate 1 or the second substrate 41 facing the liquid crystal layer 51. A liquid crystal layer 51 made from super twist nematic (STN) liquid crystal is sealed in a clearance between the opposite electrode 42 and the display electrode 31.

Under a bright external environment, reflection incoming light 65 from external light is elliptically polarized by the polarizing film 55 and the optical compensator 56 and modulated depending on a voltage applied to the liquid crystal layer 51 to reach the cathode electrode 24 that is the reflective electrode. Then, the light is polarized in a reversely twisted manner by the reflective electrode to pass through the liquid crystal layer 51 again and pass through the optical compensator 56 and the polarizing film 55 and is emitted to the viewer's side as reflection outgoing light 66. Display is performed by controlling strong reflective light and very weak reflective light according to electro-optic change of the liquid crystal layer 51.

The optical compensator 56 is constituted of a 1/4 wavelength film and a 1/2 wavelength film combined and it is set such that reflective light from the reflective electrode is made minimum averagely by the polarizing film 55 in the whole wavelength region of a visible light region when a phase contrast in the liquid crystal layer 51 is approximately 0,

On the other hand, under a dark external environment, since it becomes difficult to recognize lights and darks from reflective display performed by the liquid crystal display element, the EL element 33 is lighted. At that time, a voltage for reducing retardation, namely, a large voltage is applied to the liquid crystal layer 51. This is for employing such a constitution that light emitted from the EL element 33 is hardly absorbed in the liquid crystal layer 51 and retardation hardly occurs in the liquid crystal layer 51. It is desirable for preventing reflection from the cathode electrode 24 efficiently under a bright external environment to provide the polarizing film 55 and the optical compensator 56.

Moreover, in the eleventh embodiment, since the EL control switching element 17 provided on the first substrate 1 is covered with the cathode electrode 24 in the EL element 33 even in the liquid crystal display device using the passive matrix type display panel like in the first embodiment, the EL control switching element 17 does not block the EL element 33. Accordingly, a bright EL element 33 can be obtained.

Since the reflectivity of the cathode electrode 24 is utilized as the reflective electrode in the liquid crystal display element, the reflective electrode in the liquid crystal display element is prevented from being blocked by the EL control switching element 17. Accordingly, bright reflective display performed by the liquid crystal display element is made possible. Furthermore, when displaying is performed by light emission from the EL element 33, outgoing of reflective light at the cathode electrode 24 which is the reflective electrode is prevented by the polarizing film 55 and the optical compensator 56, so that a contrast between the reflective light and the transmissive outgoing light 61 from the EL element 33 can be made large.

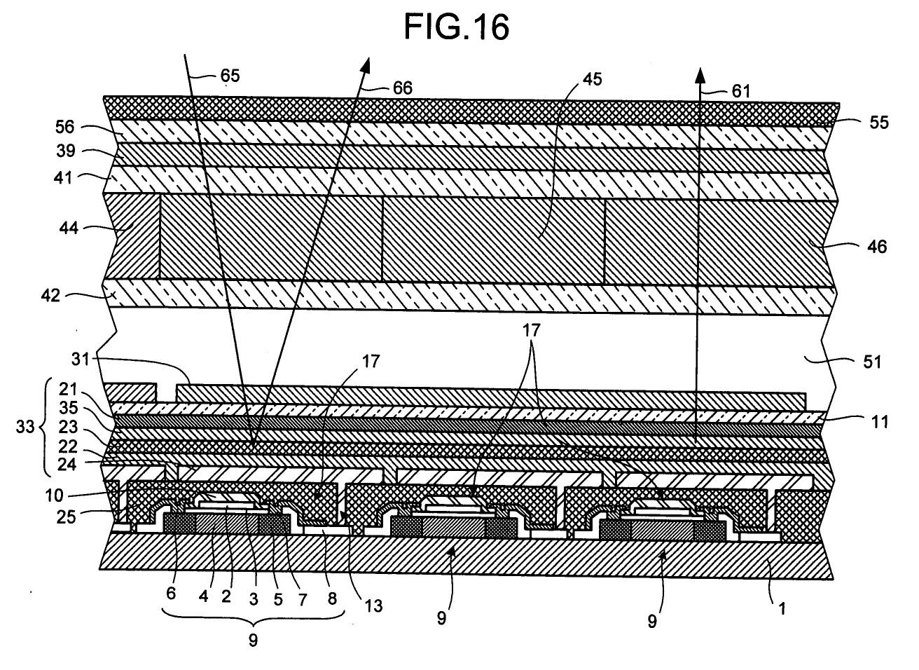

A liquid crystal display device according to a twelfth embodiment is explained below with reference to FIG. 16. A feature of a twelfth embodiment lies in a point that a color filter is provided between a light emitting element and a second substrate in a liquid crystal display device with an EL element and a switching element for controlling the EL element incorporated in a liquid crystal display panel of a passive matrix type. Further, one of features is that light emission from the light emitting element is white color light. In the liquid crystal display device according to the twelfth embodiment, a liquid crystal layer switching element is not provided. FIG. 16 is a partial enlarged sectional view of a liquid crystal display device according to the twelfth embodiment of the present invention. The twelfth embodiment will be explained below with reference to FIG. 16.

An EL control switching element 17 is provided in each pixel. A passivation film 10 and an interlayer insulating film 25 that is an insulating film are provided on the switching element 17 and the interlayer insulating film 25 is planarized like in the first embodiment. A cathode electrode 24 that is a reflective metal electrode serving as a third electrode is formed on the interlayer insulating film 25 from alloy of aluminum and magnesium. An electron transporting layer 22 made from quinolinolenic aluminum complex (Alq), a light emitting layer 23 made of quinolinolenic aluminum complex doped with quinacridone, a hole transporting layer 35 made from triphenylamine derivative, and an anode electrode 21 of a fourth electrode made from indium tin oxide (ITO) film as a transparent electric conductive film are stacked on the cathode electrode 24 in this order. The EL element 33 is constituted of constitutions positioned from the cathode electrode 24 to the anode electrode 21.

An insulating film for protection 11 is provided on the EL element 33 for preventing moisture penetration into the EL element 33 and for preventing degradation of the EL element 33 at subsequent steps. A stripe-like display electrode 31 made from a transparent electric conductive film is provided on the insulating film for protection 11.

The second substrate 41 is opposed to the first substrate 1 to be spaced by a predetermined clearance. A red color filter 45 that allows transmission of light in a red color visible light wavelength region, a blue color filter 44 that allows transmission of light in a blue color visible light wavelength region, and a green color filter 46 that allows transmission of light in a green color visible light wavelength region are provided on a face of the second substrate 41 facing the liquid crystal layer 51. A stripe-like opposite electrode 42 extending in a direction approximately orthogonal to the display electrode 31 is provided on faces of the red, blue, and green color filters 45, 44, 46 facing the liquid crystal layer 51. A crossing portion of the display electrode 31 and the opposite electrode 42 is a liquid crystal display pixel. An orientation film (not shown) that arranges liquid crystal molecules in a predetermined direction is provided on a face of the first substrate 1 or the second substrate 41 facing the liquid crystal layer 51. A liquid crystal layer 51 made from super twist nematic (STN) liquid crystal is sealed in a clearance between the opposite electrode 42 and the display electrode 31.

A light diffusion layer 39, an optical compensator 56, and a polarizing film 55 are provided on a face of the second substrate 41 opposed to the liquid crystal layer 51 in this order from the second substrate 41. The light diffusion layer 39 is obtained by mixing dispersing materials (spacer) different in refractive index in acrylic resin. Reflection outgoing light 66 from the liquid crystal display element and transmissive outgoing light 61 from the EL element 33 are diffused by the light diffusion layer 39, so that visibility can be improved.

Under a bright external environment, reflection incoming light 65 from external light is elliptically polarized by the polarizing film 55 and the optical compensator 56 and modulated depending on a voltage applied to the liquid crystal layer 51 to reach the cathode electrode 24 that is the reflective electrode. Then, the light is polarized in a reversely twisted manner by the reflective electrode to transmit the liquid crystal layer 51 again, transmit either of the color filters 44, 45, 46, and transmit the optical compensator 56 and the polarizing film 55, and goes out to the viewer's side as colored reflection outgoing light 66.

On the other hand, under a dark external environment, since it becomes difficult to recognize lights and darks from reflective display performed by the liquid crystal display element, the EL element 33 is lighted. At that time, a voltage for reducing retardation, namely, a large voltage is applied to the liquid crystal layer 51. This is for employing such a constitution that light emitted from the EL element 33 is hardly absorbed in the liquid crystal layer 51 and retardation hardly occurs in the liquid crystal layer 51. Transmissive outgoing light 61 from the EL element 33 is changed to colored light by the color filters 44, 45, 46 to go out towards a viewer's side. That is, the color filters 44, 45, 46 have both of a function for coloring reflective display using liquid crystal and a function for coloring light emission display using the EL element 33.

Thus, in the twelfth embodiment, coloring is made possible both in reflective display and in light emission display owing to the color filters 44, 45, 46 even in a liquid crystal display device using the passive matrix type display panel. Since such a constitution is employed like in the first embodiment that the EL control switching element 17 provided on the first substrate 1 is covered by the cathode electrode 24 in the EL element 33, the EL control switching element 17 is prevented from blocking the EL element 33. Accordingly, a bright EL element 33 can be obtained.

In the liquid crystal display element, because the reflectivity of the cathode electrode 24 is utilized as the reflective electrode in the liquid crystal display element, the reflective electrode in the liquid crystal display element is prevented from being blocked by the EL control switching element 17. Accordingly, bright reflective display performed by the liquid crystal display element is made possible.

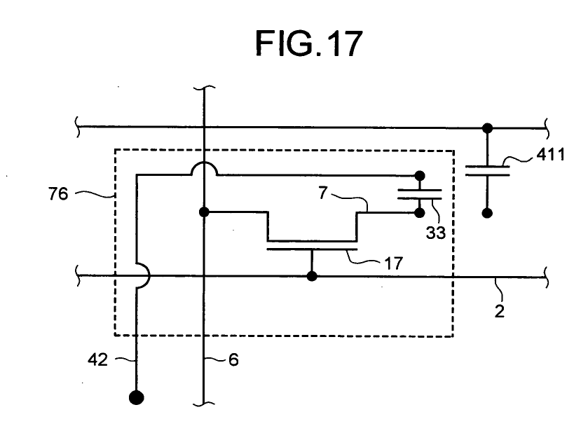

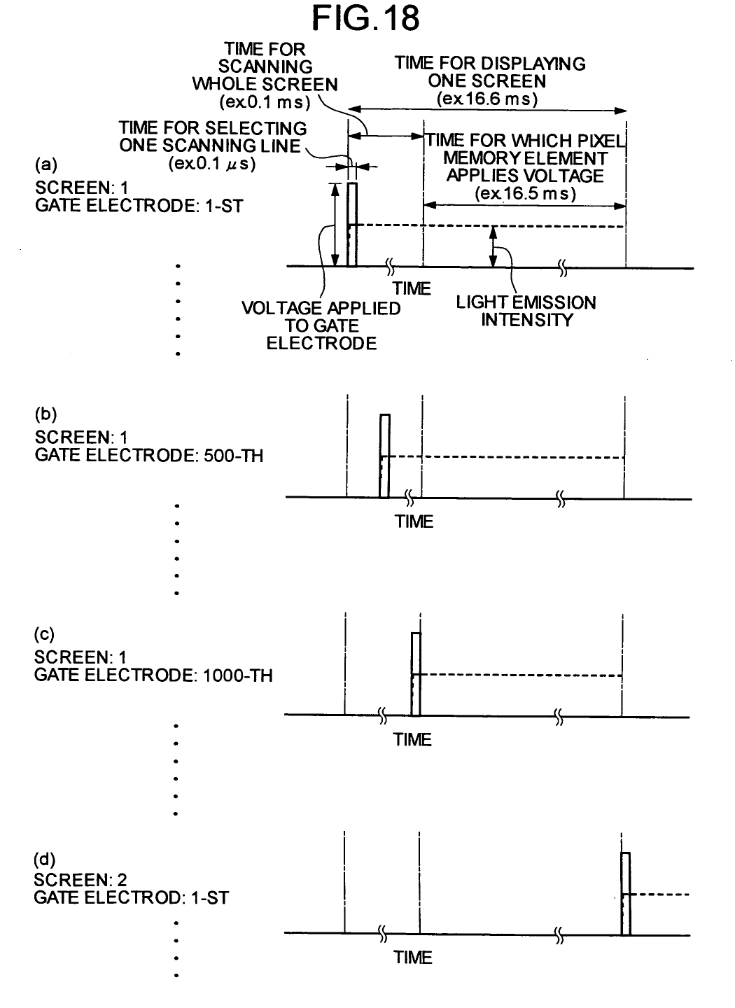

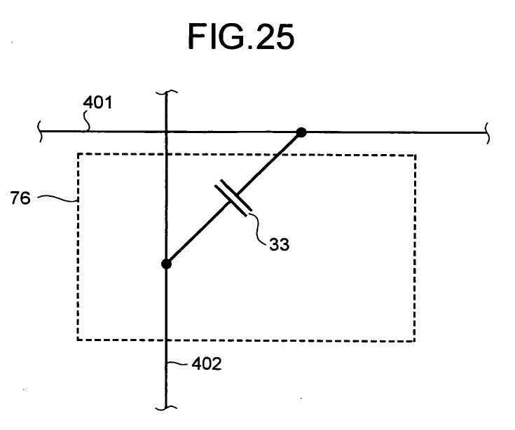

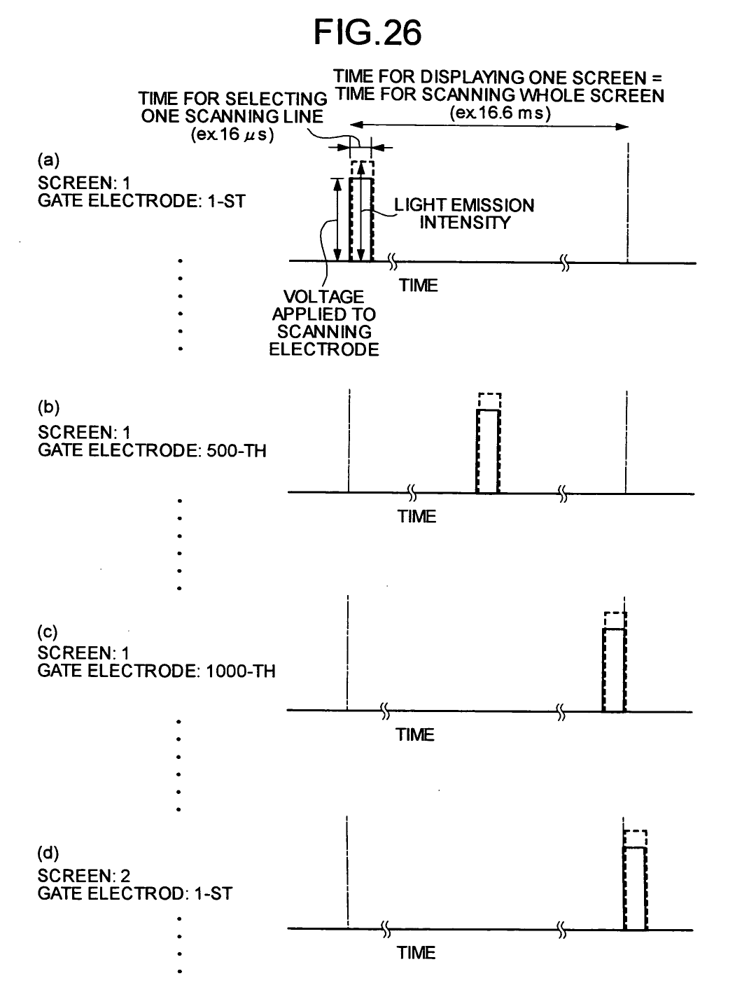

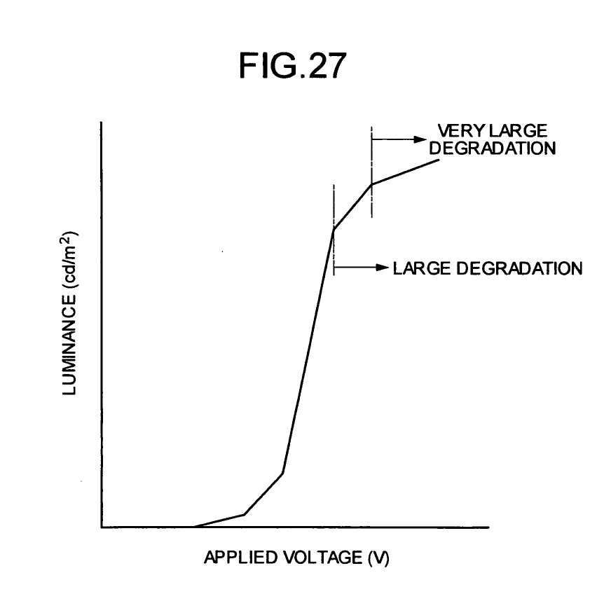

FIG. 17 is a circuit diagram of an equivalent circuit of an EL element in each of the liquid crystal display devices according to the first to twelfth embodiments. FIGS. 18A to 18D are waveforms of voltages applied to a gate electrode and light emission intensities when an EL element in each liquid crystal display device according to the first to twelfth embodiments is driven in a time divisional manner. FIG. 25 is a circuit diagram of an equivalent circuit of a passive matrix type EL element. FIGS. 26A to 26D are waveforms of voltages applied to a scanning electrode and light emission intensities when a passive matrix type EL element is driven in a time divisional manner. FIG. 27 is a characteristic graph of a relationship between luminance of an organic EL element and an applied voltage. Advantages obtained by driving an EL element as an active matrix system will be explained below with reference to FIGS. 17, 18A to 18D, 25, 26A to 26D, and 27 like in the above first to twelfth embodiments.

As shown in FIG. 25, in the passive matrix type, a stripe-like scanning electrode 401 and a stripe-like data electrode 402 extending in a direction approximately orthogonal to the scanning electrode 401 are provided. An organic EL element 33 provided at each display pixel region 76 is arranged at each crossing point of the scanning electrode 401 and the data electrode 402, and it is connected between the scanning electrode 401 and the data electrode 402. When a selecting signal is applied to the scanning electrode 401 and a data signal is applied to the data electrode 402 by a driving circuit (not shown), an EL element 33 connected to the scanning electrode 401 selected by the selecting signal and the data electrode 402 applied with the data signal is lighted. A plurality of scanning electrodes 401 are sequentially selected so that time divisional driving is performed.

In the time divisional driving of the passive matrix type EL element, for example, when the number of scanning electrodes 401 is 1000, as shown in FIG. 26A, time for displaying one screen is 16.6 milliseconds in a case of a frequency of 30 Hertz. Since 1000 scanning electrodes 401 are sequentially selected for the one screen display time, the time required for scanning each electrode becomes 16 microseconds. That is, the time for which a voltage of the selecting signal is applied to each scanning electrode 401 is 16 microseconds.

In FIGS. 26A to 26D, aspects that EL elements connected to respective scanning electrodes 401 and applied with data signals are lighted only during applications of voltages to the 1-st (FIG. 26A), 500-th (FIG. 26B), and 1000-th (FIG. 26C) scanning electrodes of one screen, and 1-st (FIG. 26D) scanning electrode 401 of the next screen are shown. Simultaneously with termination of voltage application to the 1-st scanning electrode 401, a voltage is applied to the 2^{nd} scanning electrode 401. Thereafter, voltages are sequentially applied until the 1000-th scanning electrode 401 is applied with a voltage. Simultaneously with termination of the voltage application to the 1000-th scanning electrode 401, display of the next screen is started and a voltage is applied to the 1-st scanning electrode 401 again.

Since the organic EL element has a fast response speed, it is lighted simultaneously with application of a voltage thereto, and it is turned off simultaneously with termination of the voltage application. Therefore, a lighting time of each organic EL element is 16 microseconds. That is, each organic EL element is lighted for only 16 microseconds of 16.6 milliseconds corresponding to time for displaying one screen, and it is turned off until lighting is performed on the next screen. However, it appears to a viewer owing to afterimage effect that the EL element is lighting during one screen displaying. In FIGS. 26A to 26D, waveforms drawn with a solid line represent a voltage applied to a scanning electrode, while waveforms drawn with a broken line represent light emission intensities.

When the number of scanning electrodes 401 is increased and a voltage applying time to each scanning electrode 401 is shortened, it becomes impossible to maintain a sufficient light emission luminance over the time for one screen displaying one screen. Therefore, to obtain a sufficient light emission luminance over the time for one screen displaying one screen even if a voltage applying time to each scanning electrode 401 is short, as shown in FIG. 27, it is necessary to increase a voltage to be applied to each organic EL element and increase light emission luminance significantly by causing a large current to flow in a short time. However, when a voltage applied to the organic EL element is increased, degradation of the organic EL element is accelerated.

For example, light emission luminances of an organic EL element required when the number of scanning electrodes is 1, 50, 100, and 1000 are 100 dc/m², 5000 dc/m², 10000 dc/m², and 100000 cd/m², respectively. At that time, applied voltages are respectively 3.5 volts, 5.0 volts, 7.0 volts, and 11.0 volts. Half periods indicating the degree of degradation of an organic EL element when the number of scanning electrode is 1, 50, 100, and 1000 become 50000 hours, 15000 hours, 3500 hours, and 500 hours, respectively.

Thus, characteristic degradation proceeds remarkably due to increase in applied voltage. Accordingly, organic EL elements are incorporated into a liquid crystal display device like each of the embodiments described above, the life of the organic EL elements are remarkably reduced as compared with the life of a liquid crystal, if driving of the organic EL elements is performed by the passive matrix system. In addition, unevenness occurs in light emission display performed by organic EL elements due to fluctuation in characteristic degradation speed among the respective organic EL elements at a relatively early date. When the organic EL elements are incorporated into the liquid crystal display device, there is a problem that these drawbacks should be solved.

To solve such a problem, like in the first to twelfth embodiments described above, EL elements incorporated in a liquid crystal display device are driven by an active matrix system. As shown in FIG. 17, the drain electrode 7 in the EL control switching element 17 is connected to a memory element 411 constituted of a capacitor. As shown in FIGS. 18A to 18D, for example, when the number of gate electrodes is 1000, a time required for selecting all 1000 gate electrodes (i.e., time for scanning whole screen) is set to about 0.1 millisecond relative to 16.6 milliseconds corresponding to time for one screen displaying one screen at a frequency of, for example, 30 Hertz. Since 1000 gate electrodes are sequentially selected during the time for scanning the whole screen, the time required for selecting each gate electrode is 0.1 microsecond. That is, the time for which a voltage of a selecting signal is applied to each gate electrode is 0.1 microsecond.

Aspects that EL elements are lighted for time for one screen displaying one screen by applying the 1-st (FIG. 18A), 500-th (FIG. 18B), and 1000-th (FIG. 18C) gate electrodes of one screen, and 1-st (FIG. 18D) gate electrode of the next screen are shown. Simultaneously with termination of voltage application to the 1-st gate electrode, a voltage is applied to the 2^{nd} gate electrode. Thereafter, voltages are sequentially applied up to the 1000-th gate electrode, and after the voltage application to the 1000-th gate electrode, displaying of the next screen is started simultaneously with the time for one screen displaying one screen is terminated, so that a voltage is applied to the first gate electrode again. In FIGS. 18A to 18D, waveforms that are drawn with a solid line represents voltage applied to a gate electrode while waveforms that are drawn with a broken line represent light emission intensities.

During 0.1 microseconds where a voltage of a selecting signal is applied to each gate electrode, an EL element is lighted by voltage application to the gate electrode and simultaneously charge is accumulated in the memory element 411. After the voltage application to each gate electrode is terminated, charge is supplied from the memory element 411 to the EL element. Thereby, after application of a voltage to the gate electrode is terminated, the EL element is actually put in a lighted state for most of a time elapsing until the gate electrode is selected at a time of the next screen display. Therefore, even if a large current is not caused to flow in the EL element in a short time like the case that the passive matrix type organic EL element is driven in a time divisional manner, a sufficient large light emission luminance can be achieved. Accordingly, since the characteristic degradation speed of the EL element can be made remarkably slow, the life of the EL element that is in no way inferior to that of the liquid crystal can be obtained.

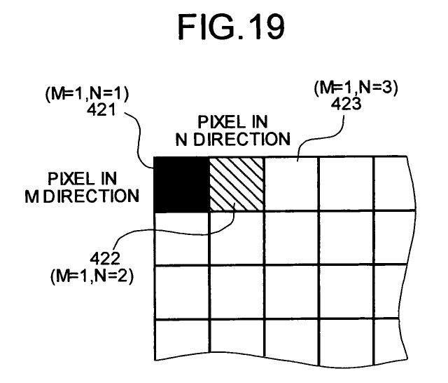

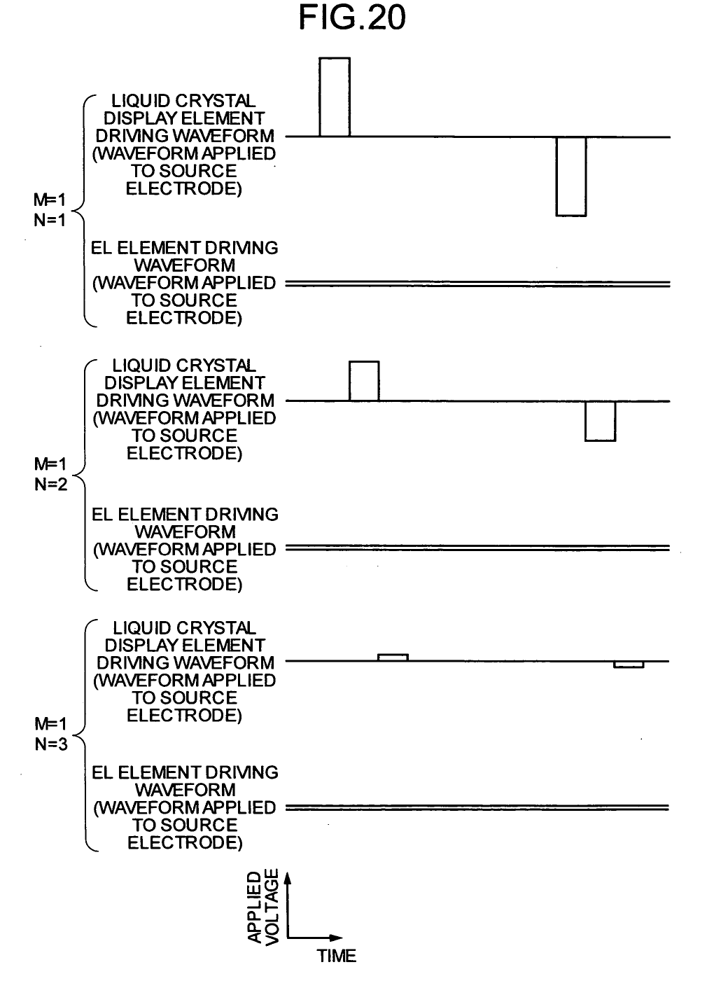

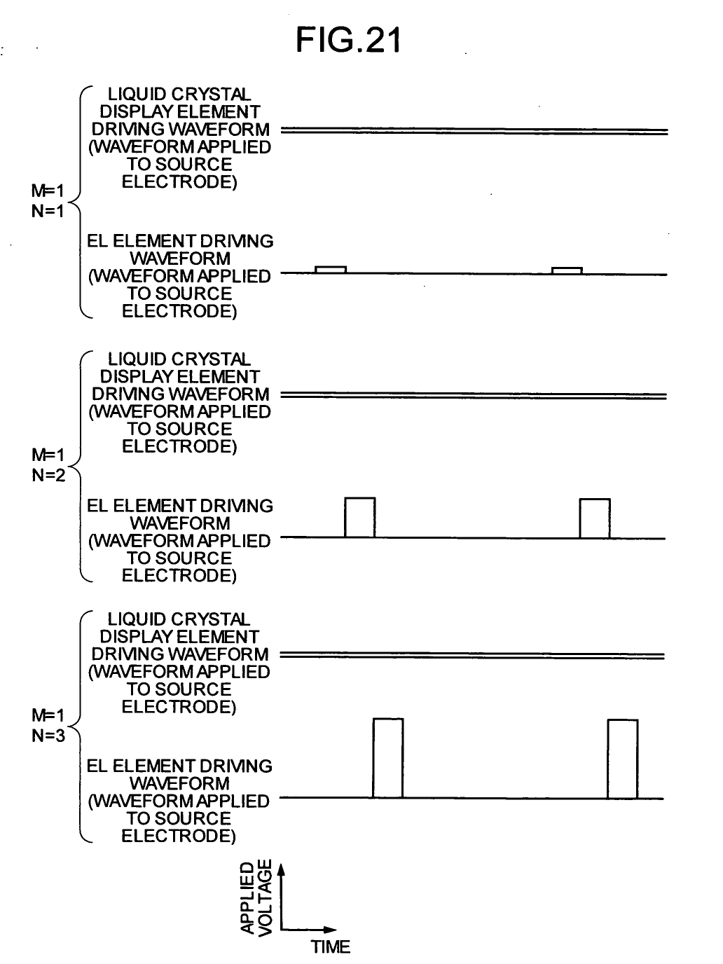

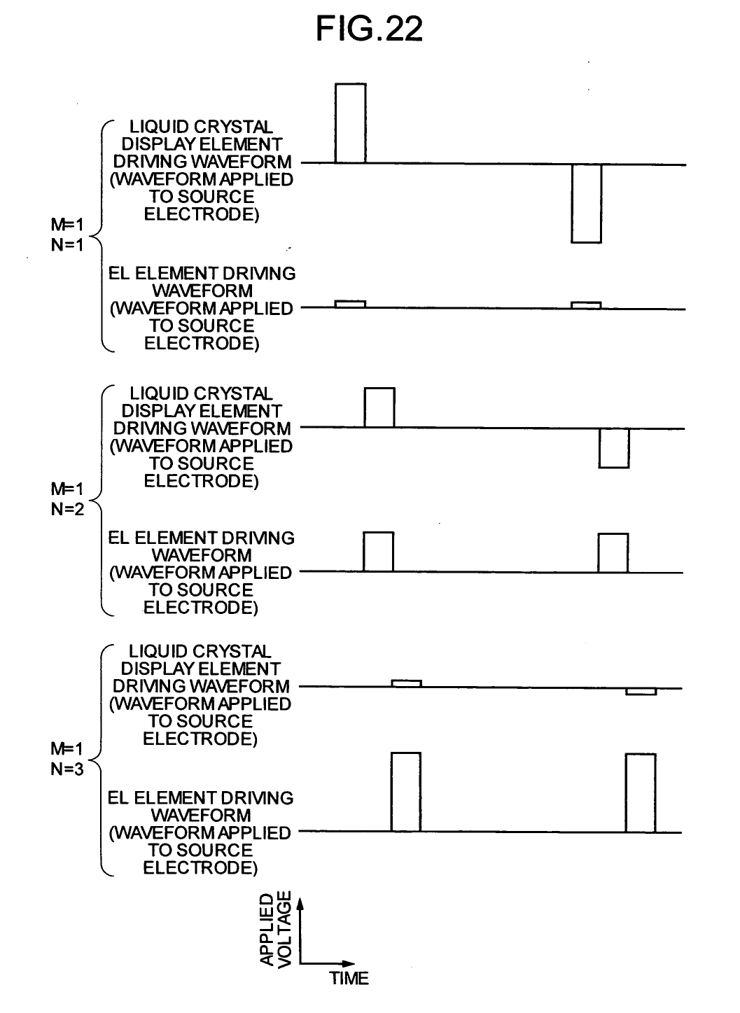

Next, operations performed when only a liquid crystal display element is driven, when only an EL element is driven, and when both a liquid crystal display element and an EL element are driven will be explained in each of the first to twelfth embodiments described above. FIG. 19 is a partial enlarged view of a display unit of a liquid crystal display device. FIG. 20 is a diagram showing driving waveforms when only a liquid crystal element is driven. FIG. 21 is a diagram showing driving waveforms when only an EL element is driven. FIG. 22 is a diagram showing driving waveforms when both a liquid crystal display element and an EL element are driven. Respective driving patterns will be explained below with reference to FIGS. 19, 20, 21, and 22.

With regards to FIG. 19, it is assumed that a pixel 421 positioned at a left and upper corner is defined as a pixel with M=1 and N=1, a pixel 422 adjacent to the pixel 421 with M=1 and N=1 on the right side thereof is defined as a pixel with M=1 and N=2, and a pixel 423 adjacent to the pixel 422 with M=2, and N=2 on the right side thereof is further defined as a pixel with M=1 and N=3. For convenience of explanation, the pixel 421 with M=1 and N=1 blacked is defined as a black display, and the pixel 422 with M=1 and N=2 hatched is defined a gray display, and the pixel 423 with M=1 and N=3 is defined as white display. The liquid crystal display element is defined as a normally white type that becomes transparent during non-application of a voltage.

First, a case that only a liquid crystal display element is driven will be explained. As shown in FIG. 20, regarding the pixel 421 with M=1 and N=1 that is the black display, a liquid crystal display element driving waveform (a source electrode applying waveform) becomes a waveform that applies the maximum voltage to a liquid crystal layer such that the transmissivity of the liquid crystal layer becomes minimum. Incidentally, the liquid crystal display element is ac-driven to prevent a liquid crystal from degrading. Regarding the pixel 422 with M=1 and N=2 that is the gray display, the liquid crystal display element driving waveform (the source electrode applying waveform) becomes a waveform that applies a proper voltage lower than the maximum voltage to the liquid crystal layer such that the transmissivity of the liquid crystal display layer becomes a transmissivity corresponding to a gradation of gray display. Regarding the pixel 423 with M=1 and N=3 that is the white display, the liquid crystal display element driving waveform (the source electrode applying waveform) becomes a waveform that applies the maximum voltage to the liquid crystal layer such that the transmissivity of the liquid crystal layer becomes maximum or a voltage is not applied to the liquid crystal layer. At that time, the EL elements light with the maximum luminance. Regarding the respective pixels, a voltage is not applied to the EL elements.

A case that only an EL element is driven will be explained. As shown in FIG. 21, regarding the pixel 421 with M=1 and N=1 that is the black display, an EL element driving waveform (a source electrode applying waveform) becomes a waveform that applies the minimum voltage to an EL element or a voltage is not applied to the EL element. At that time, the EL element does not light. Regarding the pixel 422 with M=1 and N=2 that is the gray display, the EL element driving waveform (the source electrode applying waveform) becomes a waveform that applies a proper voltage lower than the maximum voltage to the EL element such that a luminance of the EL element becomes a luminance corresponding to a gradation of gray display. Regarding the pixel 423 with M=1 and N=3 that is the white display, the EL element driving waveform (the source electrode applying waveform) becomes a waveform that applies the maximum voltage to the EL element. At that time, the EL elements light with the maximum luminance. Regarding the respective pixels, a voltage is not applied to the liquid crystal display to maximize a transmissivity of a liquid crystal layer.

The case that both the liquid crystal element and the EL element are driven is as follows. As shown in FIG. 22, regarding the pixel 421 with M=1 and N=1 that is the black display, the liquid crystal display element driving waveform (the source electrode applying waveform) becomes a waveform that applies the maximum voltage to a liquid crystal layer such that the transmissivity of the liquid crystal becomes minimum. The EL element driving waveform (the source electrode applying waveform) becomes a waveform that applies the minimum voltage to the EL element such that the EL element does not light, or a voltage is not applied to the EL element. Accordingly, a very dark black display is made possible. Regarding the pixel 422 with M=1 and N=2 that is the gray display, the liquid crystal display element driving waveform (the source electrode applying waveform) becomes a waveform that applies a proper voltage lower than the maximum voltage to the liquid crystal layer such that the transmissivity of the liquid crystal display layer becomes a transmissivity corresponding to a gradation of gray display. Simultaneously, the EL element driving waveform (the source electrode applying waveform) becomes a waveform that applies a proper voltage lower than the maximum voltage to the EL element such that a luminance of the EL element becomes a luminance corresponding to a gradation of gray display. Regarding the pixel 423 with M=1 and N=3 that is the white display, the liquid crystal display element driving waveform (the source electrode applying waveform) becomes a waveform that applies the maximum voltage to the liquid crystal layer such that the transmissivity of the liquid crystal layer becomes the maximum or a voltage is not applied to the liquid crystal layer. The EL element driving waveform (the source electrode applying waveform) becomes a waveform that applies the maximum voltage to the EL element such that the EL elements lights with the maximum luminance. Accordingly, very bright white display is made possible.

In the case that the liquid crystal display panel is a panel of a passive matrix type, there are also three operation patterns of a case that only the EL element is driven and the liquid crystal display element is not driven, a case that only the EL element is driven and the liquid crystal display element is not driven, and a case that both the liquid crystal display element and the EL element are driven. Driving waveforms of the respective operation patterns are not shown specifically, but they are similar to those shown in FIGS. 20 to 22. Incidentally, there is a difference in liquid crystal display element driving waveform between the passive matrix type and the active matrix type.

A thirteenth embodiment relates to a product to which the present invention is applied. The liquid crystal display devices according to the first to twentieth embodiments can be applied to a portable telephone. Specifically, foldable-type portable telephones provide a bigger display screen, in view of an increase in the length of mail notifications, and also prevent erroneous operations when not being used. In the foldable-type portable telephones, since display content on a main liquid crystal display panel can not be seen while the telephone is folded, generally an auxiliary liquid crystal display panel is provided on the lid. By providing the auxiliary liquid crystal display panel, although limited, information can be displayed in the folded state. In the thirteenth embodiment, one or both of the main liquid crystal display panel and the auxiliary liquid crystal display panel are applied with each of the liquid crystal display devices according to the first to twelfth embodiments.

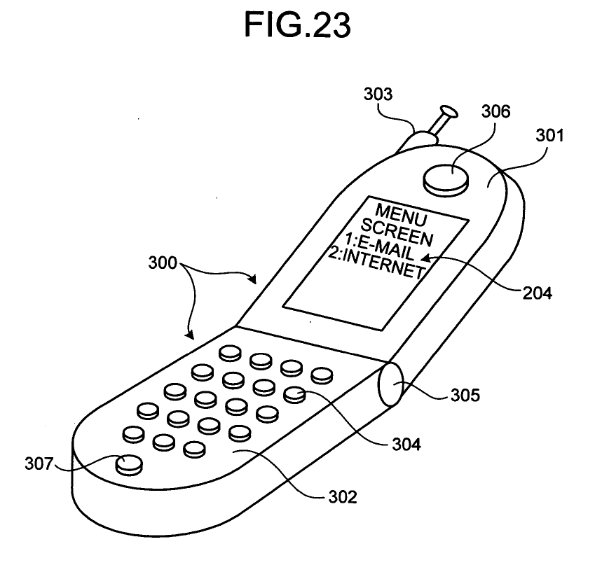

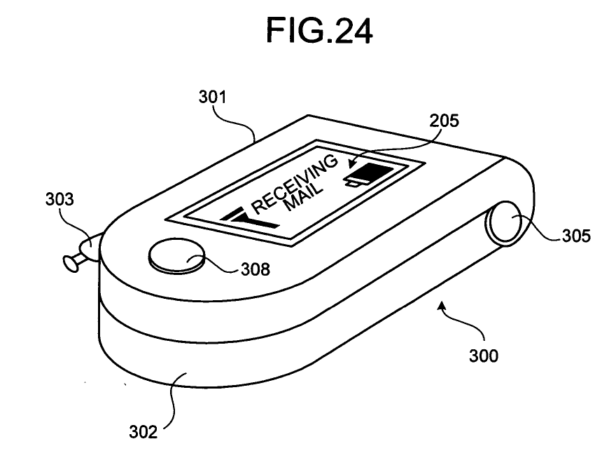

A structure of a foldable-type portable telephone will be explained using FIGS. 23 and 24. FIG. 23 is a perspective view showing a state that a lid portion of a portable telephone is opened from a portable telephone main unit and characters or an image is displayed on a main liquid crystal display panel (a first display panel). FIG. 24 is a perspective view showing a state that the lid of the portable telephone is closed so that the portable telephone is reduced in size, and characters or an image is displayed on an auxiliary liquid crystal display panel (a second display panel) while the main liquid crystal display is put in a non-display.

As shown in FIG. 23, a portable telephone 300 is constituted to be openable and closable through a hinge 305. A plurality of input buttons 304 for performing numeral or character input, mode selection, power switching, screen scrolling and the like, and a microphone 307 are provided in a portable telephone main unit 302. A first display panel 204 and a second display panel 205 are disposed on a portable telephone lid portion back to back, and a speaker 306 is provided on a first display panel mounting side.

Communication content, mail content, Internet information, telephone number, remaining battery level, information required for a user are displayed on the first display panel 204 as first display panel display contents.

The portable telephone back lid 301 is provided with an antenna 303 and an image pickup element 308. In a closed state of the portable telephone back lid 301, the second display panel 205 is put in a displaying state. Shooting state of the image pickup element 308, mail reception formation, signal reception information, remaining battery level, and information about the portable telephone are displayed on the second display panel 205. In general, a display volume of the second display panel 205 is reduced as compared with that of the first display panel 204.

When the portable telephone 300 where each of the liquid crystal display devices according to the first to twelfth embodiments described above is applied to the first display panel 204 is used, a user thereof can view reflective display according to the liquid crystal display element of the first display panel 204 under a bright external environment. Under a dark external environment, the user can view light emission display according to the EL element of the first display panel 204 by pushing an EL light emitting button (not shown).

When the portable telephone 300 where each of the liquid crystal display devices according to the first to twelfth embodiments described above is applied to the second display panel 205 is used, a user thereof can view reflective display based upon the liquid crystal display element of the second display panel 205 under a bright external environment. Under a dark external environment, the user can view light emission display according to the EL element of the second display panel 205 by pushing the EL light emitting button (not shown).

In the above embodiments, though constitution of a low-molecular base EL element has been explained as the light emitting element, the present invention is not limited to the low-molecular base EL element, and it can use a high-molecular base EL element, of course. The structure of the organic EL element is not limited to the structures of the embodiments described above, but the organic EL element may be provided with a hole injection layer or an electron injection layer.

As explained above, since the liquid crystal display device according to the present invention has the light emitting element on a side of a substrate constituting the liquid crystal display element that faces a liquid crystal, it can be relatively thinned as compared with a case that a light emitting element is arranged outside the liquid crystal panel. Since connection of the liquid crystal display element and an external circuit or connection of a light emitting element and a external circuit can be achieved on the same substrate, handling can be simplified very much.

By forming the light emitting element with the EL element, it is made possible to increase a light emission efficiency and achieve a low power consumption. Further, since the light emitting layer of the EL element is a thin film, thinning is made possible. In addition, since the cathode electrode in the EL element is constituted of a metal electrode with a small work function, it is made possible to cause the cathode electrode to serve as the reflection film of the liquid crystal display element.

Since two kinds of switching elements of the switching element for EL element control and the liquid crystal layer switching element are formed on the first substrate to control the EL element and the liquid crystal display element, it is made possible to utilize displaying performances of individual display elements to the utmost extent. In particular, by forming the EL element on a layer above the switching element, light emission from the EL element is prevented from being blocked by the switching element, so that it is made unnecessary to consider an area for forming the switching element. Further, by utilizing the reflective electrode constituting the EL element as the reflection film for the liquid crystal display element, such a constitution that the liquid crystal display element is overlapped on the EL element can be adopted, so that a high aperture ratio can be not only secured but also emission light from the EL element is prevented from being blocked. That is, bright EL display and bright reflective display from the liquid crystal display element can be achieved.

Since the liquid crystal is sealed by the sealing member, the liquid crystal display element can prevent moisture from mixing in the liquid crystal. Therefore, degradation of the EL element due to moisture can be prevented. Further, by providing a protective film made from, for example, a silicon nitride film on the EL element, degradation of the EL element due to moisture can be further reduced.

Further, by producing the first electrode constituting the liquid crystal display element as the reflective electrode, bright display based upon the liquid crystal display element can be achieved and such a structure that emission light from the liquid crystal display element is caused to go out toward the first substrate can be employed. Accordingly, a user can recognize reflective display according to the liquid crystal display device through the second substrate and can recognize light emission display according to the light emitting element through the first substrate. That is, duplex display in the liquid crystal display device can be made possible.

When the first electrode is provided on the light emitting element as the reflective electrode, it is made possible to recognize both reflective display according to the liquid crystal display element and light emission display according to the light emitting element through the second substrate by employing the constitution that an opening is provided in the reflective electrode so that emission light from the light emitting element is caused to pass through the opening. Further, by producing the cathode electrode provided on the light emitting element on the side of the first substrate as the reflective electrode, it is made possible to make up for lowering of a reflection intensity according to a reflective electrode opening provided in the first electrode by reflection from the reflective cathode electrode. As described above, reflective display and light emission display can be recognized on the same face, and reflective display can be performed as bright display.

By providing an undulated face for scattering incoming light on a protective film provided between the light emitting element and the first electrode, bright display is made possible at a predetermined angle according to the reflective display, and a reflection intensity is reduced on the light emission display except for the predetermined angle so that display from the light emitting element can be made sharp. By providing the optical compensator and the polarizing film on the viewer's side of the first substrate from the first substrate and forming the optical compensator from a 1/4 wavelength film or forming 1/4 wavelength from the optical compensator and liquid crystal, it is made possible to prevent reflection from the reflection film and it is made possible to improve contrast during light emission of the light emitting element.

By forming a color filter incorporated into a liquid crystal display on an inner face (a face on the side of the liquid crystal layer) of the second substrate, the color filter can be caused to approach to the liquid crystal, so that interference between color filters does not occur and blur of pixels can be prevented.

Further, by imparting a light diffusing property to the planarizing protective film or the EL step planarizing film provided on the light emitting element and incorporating a light diffusing function in the planarizing protective film or the EL step planarizing film, a viewing angle dependency of reflective display according to the liquid crystal display element can be reduced. Since emission light from the light emitting element can be diffused, a visibility of light emission display according to the light emitting element is also improved. As described above, instead of incorporation of the light diffusing function, such a constitution may be employed that an auxiliary light diffusing function is provided between the optical compensator and the second substrate or between the polarizing film and the optical compensator. In this case, back scattering to incoming light from a viewer's side due to the auxiliary light diffusing function ca be reduced and water permeability due to scattering members required when the light diffusing function is incorporated into the planarizing protective film or the EL step planarizing film can be prevented from increasing so that a reliability of the light emitting element can be improved.

Since the switching element is provided for each display pixel to drive the EL element and each EL element is driven according to the active matrix system, even if the number of display pixels arranged in the matrix manner is increased and a selecting time for lighting each EL element is shortened, sufficiently bright light emission display can be obtained without imparting a large stress on the EL element. Accordingly, a long life of the EL element can be achieved. On the other hand, when each EL element is driven according to the passive matrix system, if a selecting time for lighting each EL element is shortened, it is necessary to attain high luminance corresponding to the shortening of the selecting time to maintain a predetermined brightness. When the high luminance is attained, a large stress is imparted on the EL element so that the life of the EL element is remarkably reduced. The first electrode that drives the liquid crystal display element is formed on the protective film on the semiconductor switching element.

As the liquid crystal, liquid crystal that allow lights and darks display can be used without using the polarizing film, or the polarizing film and the optical compensator. In the present invention, a guest host type liquid crystal obtained by mixing liquid crystal molecules and dichroism pigment is employed. In the guest host type liquid crystal, since light from an external light source passes through the liquid crystal layer twice, twice absorption occurs due to the dichroism pigment, so that sufficient dark display can be achieved. However, when a back light is lighted and utilization is made as a transmissive type, light passes through the liquid crystal only one time, so that sufficient dark display can not be obtained. In the present invention, therefore, liquid crystal of a pixel where a light emitting element is lighted is put in a transmitting state and liquid crystal of a pixel where a light emitting element is not lighted is put in an absorbing state, so that both light from an external light source and emission light from the light emitting element can be used simultaneously. Further, since the liquid crystal display element and the light emitting element are provided to come close to each other between the first substrate and the second substrate, the liquid crystal element and the light emitting element can be recognized as the same pixel.

As the liquid crystal, liquid crystal that allows scattering and transmissive display can be used without using the polarizing film, or the polarizing film and the optical compensator. In the present invention, scattering type liquid crystal constituted of liquid crystal molecules and transparent solid material can be adopted. In the scattering type liquid crystal, since light from an external light source passes through the liquid crystal layer twice on reflective display, scattering occurs due to the liquid crystal layer twice, so that sufficient scattering display can be achieved. However, when a back light is lighted and utilization is made as a transmissive type, light passes through the liquid crystal only one time, so that sufficient scattering display can not be obtained. In the present invention, therefore, liquid crystal of a pixel where a light emitting element is lighted is put in a transmitting state and liquid crystal of a pixel where a light emitting element is not lighted is put in an absorbing state, so that both light from an external light source and emission light from the light emitting element can be used simultaneously. Further, by controlling scattering property even in a pixel where a light emitting element is lighted, emission light from the light emitting element is diffused so that a user can recognize display from any place.

### INDUSTRIAL APPLICABILITY

As described above, the liquid crystal display according to the present invention is useful for a liquid crystal display device that, owing to integration of a liquid crystal display element performing reflective display according to time divisional driving and a light emitting element performing light emission display according to time divisional driving incorporates a light emitting element therein, and it is particularly suitable for a display device with reduced power consumption, and excellent display quality and visibility that performs reflective display according to the liquid crystal display element under a bright external environment is bright and performs light emission display according to the light emitting element under a dark external environment.

1. A liquid crystal display device where a first substrate having a display electrode and a second substrate having an opposite electrode are disposed so as to be opposed to each other via a predetermined clearance, and a liquid crystal display element having a liquid crystal layer is provided in the clearance, wherein
an electroluminescent element is provided between the first substrate and the second substrate,
the liquid crystal display element includes a first reflection film that reflects light from an external light source, and
the electroluminescent element includes a second reflection film different form the first reflection film.

2. The liquid crystal display device according to claim 1, wherein an EL control switching element for controlling the electroluminescent element is formed on a liquid crystal layer side of the first substrate, and the electroluminescent element is formed on a liquid crystal side of the EL control switching element via an insulating film.

3. The liquid crystal display device according to claim 1, wherein the electroluminescent element is formed on a liquid crystal layer side of the first substrate, and an EL control switching element for controlling the electroluminescent element is formed on a liquid crystal layer side of the electroluminescent element via an insulating film.

4. The liquid crystal display device according to claim 3, wherein the electroluminescent element allows light to transmit the first substrate to go out to a side of the first substrate.

5. The liquid crystal display device according to claim 2, wherein an EL connecting opening is formed in the insulating film, and the electroluminescent element and the EL control switching element are electrically connected to each other via the EL connecting opening.

6. The liquid crystal display device according to claim 1, wherein the electroluminescent element comprises plural kinds of electroluminescent elements that emit different color lights, respectively.

7. The liquid crystal display device according to claim 6, wherein a protective film that prevents moisture from permeating the electroluminescent element is provided on the electroluminescent element.

8. The liquid crystal display device according to claim 7, wherein an insulating planarizing film for planarizing a step is formed on the electroluminescent element or the EL control switching element, and a display electrode for the liquid crystal display element is formed on the planarizing film.

9. The liquid crystal display device according to claim 8, wherein the planarizing film is provided with a diffusing member that diffuses light.

10. The liquid crystal display device according to claim 8, wherein the display electrode is a reflective electrode and has an opening in its region overlapping with the electroluminescent element.

11. The liquid crystal display device according to claim 10, wherein a surface of the reflective electrode is formed in an undulated shape.

12. The liquid crystal display device according to claim 11, wherein a surface of the planarizing film is formed in an undulated shape.

13. The liquid crystal display device according to claim 1, further comprising a liquid crystal layer switching element for supplying a signal for display to the liquid crystal layer between the first substrate and the second substrate to be connected to the display electrode.

14. The liquid crystal display device according to claim 13, wherein a display electrode is formed on a liquid crystal layer side of the liquid crystal layer switching element, and the display electrode and the switching element for liquid crystal display layer control are electrically connected to each other via an LC connecting opening formed in the insulating film.

15. The liquid crystal display device according to claim 13, wherein
the display electrode is formed on a region that approximately covers a set of two switching elements comprising the liquid crystal layer switching element and the EL control switching element.

16. The liquid crystal display device according to claim 1, wherein
the switching element comprises a thin film transistor having a source electrode, a drain electrode, and a gate electrode.

17. The liquid crystal display device according to claim 16, wherein
the gate electrodes of the EL control switching element and the switching element for liquid crystal display element included in the same display pixel region are connected to each other and the source electrodes thereof are independent from each other.

18. The liquid crystal display device according to claim 16, wherein gate electrodes of the EL control switching elements included in two display pixel regions adjacent to each other, respectively, are connected to each other, gate electrodes of the liquid crystal layer switching elements included in two display pixel regions adjacent to each other, respectively, are connected to each other, and a source electrode of the EL control switching element is connected to a source electrode of the liquid crystal layer switching element included in an adjacent display pixel region.

19. The liquid crystal display device according to claim 16, wherein
gate electrodes of the EL control switching elements included in two display pixel regions adjacent to each other, respectively, are connected to each other, gate electrodes of the liquid crystal layer switching elements included in two display pixel regions adjacent to each other, respectively, are independent from the gate electrodes of the EL control switching elements and are connected to each other, and source electrodes of the EL control switching element and the liquid crystal layer switching element are independent from each other.

20. The liquid crystal display device according to claim 16, wherein the switching element is a thin film transistor having a semiconductor layer made of a poly-silicon thin film.

21. The liquid crystal display device according to claim 20, wherein the EL control switching element is a thin film transistor having a semiconductor layer made of a poly-silicon thin film, and the liquid crystal layer switching element is a thin film transistor having a semiconductor layer made of an amorphous silicon film.

22. The liquid crystal display device according to claim 1, comprising a color filter disposed between the first substrate and the second substrate.

23. The liquid crystal display device according to claim 1, wherein the liquid crystal layer is a mixture of liquid crystal and transparent solid material, and is a scattering type liquid crystal layer that controls scattering and transmission according to magnitude of a voltage applied to the liquid crystal layer.

24. The liquid crystal display device according to claim 1, comprising an organic insulating film mixed with a member that absorbs moisture and disposed between the first substrate and the display electrode.

25. The liquid crystal display device according to claim 1, comprising at least a polarizing film on a side of the second substrate side opposite to the side on which the liquid crystal layer is provided.

26. The liquid crystal display device according to claim 1, comprising at least one optical compensator and a polarizing film disposed on a side of the second substrate opposed from the liquid crystal layer in this order from the second substrate side.

27. The liquid crystal display device according to claim 25, comprising a light diffusing layer positioned between the electroluminescent element and the polarizing film.

28. The liquid crystal display device according to claim 1, comprising a light diffusing layer positioned between the electroluminescent element and the second substrate.

29. The liquid crystal display device according to claim 26, wherein arrangement of an orientation direction of the liquid crystal layer, and the polarizing film and the optical compensator provided on a side of the second substrate opposed from the liquid crystal layer meets arrangement where a transmissivity of the liquid crystal layer becomes approximately maximum during non-application of a voltage to the liquid crystal layer.

30. The liquid crystal display device according to claim 29, wherein a voltage where the transmissivity of the liquid crystal layer becomes approximately maximum is applied to the liquid crystal layer via the liquid crystal layer switching element during light emission from the electroluminescent element.

31. The liquid crystal display device according to claim 1, wherein a display face of the liquid crystal display element is positioned on the side of the second substrate, and a light emitting face of the electroluminescent element is positioned on the side of the first substrate.

32. The liquid crystal display device according to claim 1, wherein the first reflection film is a reflection film or a reflecting electrode for performing reflective display according to the liquid crystal display element.

33. The liquid crystal display device according to claim 1, wherein the second reflection film is a reflecting electrode constituting the electroluminescent element.

34. The liquid crystal display device according to claim 1, wherein at least one of a plurality of electrodes constituting the electroluminescent element is a transparent electric conductive film.

35. The liquid crystal display device according to claim 1, wherein an EL control switching element for controlling the electroluminescent element is formed between the first substrate and the second substrate.

36. The liquid crystal display device according to claim 1, further comprising a liquid crystal layer switching element for supplying a signal for display to the liquid crystal layer between the first substrate and the second substrate, being connected to the display electrode.

37. The liquid crystal display device according to claim 35, wherein the electroluminescent element is formed on a liquid crystal layer side of the first substrate, the EL control switching element or the liquid crystal switching element is formed on a liquid crystal layer side of the electroluminescent element via an insulating film, and the liquid crystal display element is formed on a liquid crystal layer side of the EL control switching element or the liquid crystal switching element via an insulating film.

38. The liquid crystal display device according to claim 8, wherein the display electrode is a reflective electrode, and the reflection film included in the liquid crystal display element has an opening in a region overlapped with the electroluminescent element.

39. The liquid crystal display device according to claim 1, wherein a substrate that emits reflective light for reflective display according to the liquid crystal display element is different from a substrate that emits emission light according to the electroluminescent element, from among the first substrate and the second substrate.
